(19) United States
(12) Patent Application Publication
(10) Pub. No.: US 2015/0371176 A1
(43) Pub. Date: Dec. 24, 2015

(54) MOBILE COMMUNICATION AND WORKFLOW MANAGEMENT SYSTEM

(71) Applicant: Mednology Solutions LLC d/b/a SynapseBLUE, Minneapolis, MN (US)

(72) Inventors: Matthew Barrett, Portland, OR (US); David Sullivan, Excelsior, MN (US); Scott Joing, Edina, MN (US)

(21) Appl. No.: 14/839,275

(22) Filed: Aug. 28, 2015

Related U.S. Application Data
(63) Continuation-in-part of application No. PCT/US2014/019675, filed on Feb. 28, 2014.
(60) Provisional application No. 61/770,784, filed on Feb. 28, 2013.

(51) Int. Cl. G06Q 10/06; H04L 29/08

(52) U.S. Cl. CPC G06Q 10/063114; H04L 67/10

(57) ABSTRACT

A communication and medical care management system using mobile application technology for use within the healthcare industry. The system enables faster, richer, and more direct communication within emergency departments, between departments, and between providers and their patients. It can coordinate busy healthcare resources to efficiently and effectively provide the proper care at the right place in time, resulting in cost savings.

### CROSS-REFERENCE TO RELATED APPLICATION

This application is a continuation-in-part of International Application No. PCT/US2014/019675, filed on Feb. 28, 2014, titled MOBILE COMMUNICATION AND WORKFLOW MANAGEMENT SYSTEM, which claims the benefit of U.S. Provisional Application No. 61/770,784 filed Feb. 28, 2013, titled MOBILE COMMUNICATION AND WORKFLOW MANAGEMENT SYSTEM.

### FIELD

The present invention relates to a mobile communication and medical care task system and method for use within the healthcare industry.

### BACKGROUND

Approximately 20% of all adults in the US seek care in an Emergency Department (ED) at least once per year. Unfortunately for patients, the ED experience is often marked by frustration, anxiety and seemingly endless waits. Once in an exam room, the patient may find himself talking to the back of a nurse, who is busily typing the patient's data into a computer. The physician seems to be continually interrupted by pages and the need to track down nurses or technicians. Patients are left uninformed while waiting for critical procedures or vital lab results. ED communication and workflow are woefully inefficient at a time when efficiency is of paramount importance—in management of medical emergencies.

EDs and urgent care clinics in the US are challenged to quickly provide high quality clinical outcomes while managing costs and ensuring positive patient experience. However, existing communication tools are insufficient—they are slow, inefficient and intrusive. Although the drive toward meaningful use of electronic medical records has increased traceability of patient information, this can create more time-consuming, complex processes and lower quality of provider-patient interaction. The often disjointed flow of healthcare tasks results in unnecessary staff expenses and lower throughput. In addition, many providers fail to capture appropriate reimbursement due to inadequate documentation of their care and decision-making. Finally, in certain critical situations, a delay of just a few minutes can significantly impact the outcome of a patient's health.

There are approximately 1,800 urban/suburban EDs in the US, and more than 9,000 urgent care centers that could benefit from improvement to the ED experience and from a solution for the mobile health industry.

### SUMMARY OF THE INVENTION

The present invention relates to a communication and medical care task or workflow management system and method using mobile application technology for use within the healthcare industry. The invention is independent of a medical facility's internal communication system. This technology will enable faster, richer, and more direct communication within the Emergency Department (ED), between departments, and between providers and their patients. The intelligent workflow management hardware and software is designed specifically for the emergency/urgent care environment and will coordinate busy healthcare resources to efficiently and effectively provide the proper care at the right place in time, resulting in cost savings. This tool will also remind providers to capture appropriate reimbursement coding, commensurate with the clinical care provided. By integrating mobile devices with existing software systems, the invention aims to increase patient-provider engagement by increasing face-to-face interaction.

Reference is made throughout the present disclosure to certain aspects of one embodiment of the system and method described herein. Such references to aspects of the present invention do not limit the scope of the claims attached hereto. Additionally, any examples set forth in this disclosure are not intended to be limiting and merely set forth some of the many possible embodiments for the appended claims. It is to be understood that the phraseology and terminology used herein are for the purpose of description and should not be regarded as limiting.

### BRIEF DESCRIPTION OF THE DRAWINGS

FIG. 1 is a diagram illustrating functions of one example of the mobile interface according to one embodiment of the present invention.

FIG. 2 is an example graphical user interface according to one embodiment of the present invention.

FIG. 3 is an example graphical user interface according to one embodiment of the present invention.

FIG. 4 is an example graphical user interface according to one embodiment of the present invention.

FIG. 5 is an example graphical user interface according to one embodiment of the present invention.

FIG. 6 is an example graphical user interface according to one embodiment of the present invention.

FIG. 7 is an example graphical user interface according to one embodiment of the present invention.

FIG. 8 is an example graphical user interface according to one embodiment of the present invention.

FIG. 9 is an example graphical user interface according to one embodiment of the present invention.

FIG. 10 is an example graphical user interface according to one embodiment of the present invention.

FIG. 11 is an example graphical user interface according to one embodiment of the present invention.

FIG. 12 is an example graphical user interface according to one embodiment of the present invention.

FIG. 13 is an example graphical user interface according to one embodiment of the present invention.

FIG. 14 is an example graphical user interface according to one embodiment of the present invention.

FIG. 15 is an example graphical user interface according to one embodiment of the present invention.

FIG. 16 is an example graphical user interface according to one embodiment of the present invention.

FIG. 17 is an example graphical user interface according to one embodiment of the present invention.

FIG. 18 is an example graphical user interface according to one embodiment of the present invention.

FIG. 19 is an example graphical user interface according to one embodiment of the present invention.

FIG. 20 is an example graphical user interface according to one embodiment of the present invention.

FIG. 21 is an example graphical user interface according to one embodiment of the present invention.

FIG. 22 is an example graphical user interface according to one embodiment of the present invention.

FIG. 23 is an example graphical user interface according to one embodiment of the present invention.

FIG. 24 is an example graphical user interface according to one embodiment of the present invention.

FIG. 25 is an example graphical user interface according to one embodiment of the present invention.

FIG. 26 is an example graphical user interface according to one embodiment of the present invention.

FIG. 27 is an example graphical user interface according to one embodiment of the present invention.

FIG. 28 is an example graphical user interface according to one embodiment of the present invention.

FIG. 29 is an example graphical user interface according to one embodiment of the present invention.

FIG. 30 is an example graphical user interface according to one embodiment of the present invention.

FIG. 31 is an example graphical user interface according to one embodiment of the present invention.

FIG. 32 is an example graphical user interface according to one embodiment of the present invention.

FIG. 33 is an example graphical user interface according to one embodiment of the present invention.

FIG. 34 is an example graphical user interface according to one embodiment of the present invention.

FIG. 35 is an example graphical user interface according to one embodiment of the present invention.

FIG. 36 is an example graphical user interface according to one embodiment of the present invention.

FIG. 37 is an example graphical user interface according to one embodiment of the present invention.

FIG. 38 is an example graphical user interface according to one embodiment of the present invention.

FIG. 39 is an example graphical user interface according to one embodiment of the present invention.

FIG. 40 is an example graphical user interface according to one embodiment of the present invention.

FIG. 41 is an example graphical user interface according to one embodiment of the present invention.

FIG. 42 is an example graphical user interface according to one embodiment of the present invention.

FIG. 43 is an example graphical user interface according to one embodiment of the present invention.

FIG. 44 is an example graphical user interface according to one embodiment of the present invention.

FIG. 45 is an example graphical user interface according to one embodiment of the present invention.

FIG. 46 is an example graphical user interface according to one embodiment of the present invention.

FIG. 47 is an example graphical user interface according to one embodiment of the present invention.

FIG. 48 is an example graphical user interface according to one embodiment of the present invention.

FIG. 49 is a schematic block diagram of an example computing system that may be used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

In general terms, the present invention relates to a communication and workflow management system and method using mobile application technology for use within the healthcare industry. Some of the system's features allow the system to integrate with a healthcare facility's existing communication and/or workflow system(s). These features include reliable, instant voice and text communication via mobile devices; role-based notification and escalation; and integration with EMR/EHR systems (for example, EPIC). Security features of the system include HIPAA compliance and data security; secure login for all users; and data lock and device wipe capability. The system may further include features such as patient education materials and links to reference apps.

Other features and enhancements that add value to care providers and patients include an intelligent workflow management tool developed specifically for Emergency Department (ED) and Urgent Care environments; the ability to communicate using one-touch messaging, photos and video (for example, FaceTime); staff work status view (for example, available, busy, on break, on call, etc.); passive tracking of patient and staff location within hospital or ED (indoor location) using geofencing (ex. Bluetooth beacons, wearable sensors); configurable settings based on staff location—ex. automatically set status to Do Not Disturb in no interruption zone); and passive tracking of ambulance location and proximity to hospital/ED using GPS or other technology (including configurable alerts to notify ED staff of estimated time to ambulance arrival).

Other features include an intuitive touch-based interface with icons and pull down menus (minimal text input); hands free communication capability (such as use of smartwatch technology like Pebble and Apple Watch); and physician profile and preferences (ex. glove size, preferred set-up for procedures, etc.). The system may include documentation reminders for full reimbursement. The system may further include a patient request interface, for example, to be used for patient pain management, care plan, care team and common requests. Use of the system enables greater efficiency and higher patient satisfaction from triage to discharge.

In some embodiments, the invention uses a number of hardware components to carry out its functions, as described in more detail herein. The following are examples of specific functions that may be performed by certain hardware components, according to one embodiment of the invention.

A smart phone or other mobile computing device (for example, iPhone or iPod Touch) may be used for voice/text/video communication, workflow management, patient/staff education, and/or medical reference, and may be controlled using a touch screen. This may include a hands-free response setting. A tablet device (for example, iPad) may also be used for voice/text/video communication, workflow management, patient/staff education, medical reference and/or patient distraction and entertainment. Mobile computing devices may include a mobile device case or screen protector to protect the mobile device and its screen while in use. Some mobile device accessories such as the mobile device case must be able to be sanitized for use in a healthcare setting. Mobile computing devices may be used with a Bluetooth connected headset or other device to facilitate hands free communication while using the invention. Other devices providing communication and location advantages include: smart watches (ex. Pebble; Apple Watch); GPS location tracking devices; Bluetooth beacons for location tracking; and wearable sensors on patients (ex. Angel Sensor).

Mobile device management, via Jamf, Airwatch, or others, may include setup and configuration, synchronization, security, data lock, remote device wipe, and may be BYOD compatible.

A computing device such as a desktop computer may be used for coordination, dashboard function, task management or mission control. An additional computing device such as a server (for example, Mac mini with OS X) may be used for data traffic and content management, audit tracking, device management, configuration, data storage and backup. System data may be stored on a dedicated, secure server within the ED or other department, allowing for audit capability (for example, user access or what data was accessed, with report capability), usage tracking, and data management.

A wireless router (for example, AirPort Extreme or Time Capsule) provides a Wi-Fi connection within the ED, and a wireless repeater or amplifier (for example, elevators) may also be used to enhance connectivity throughout the ED.

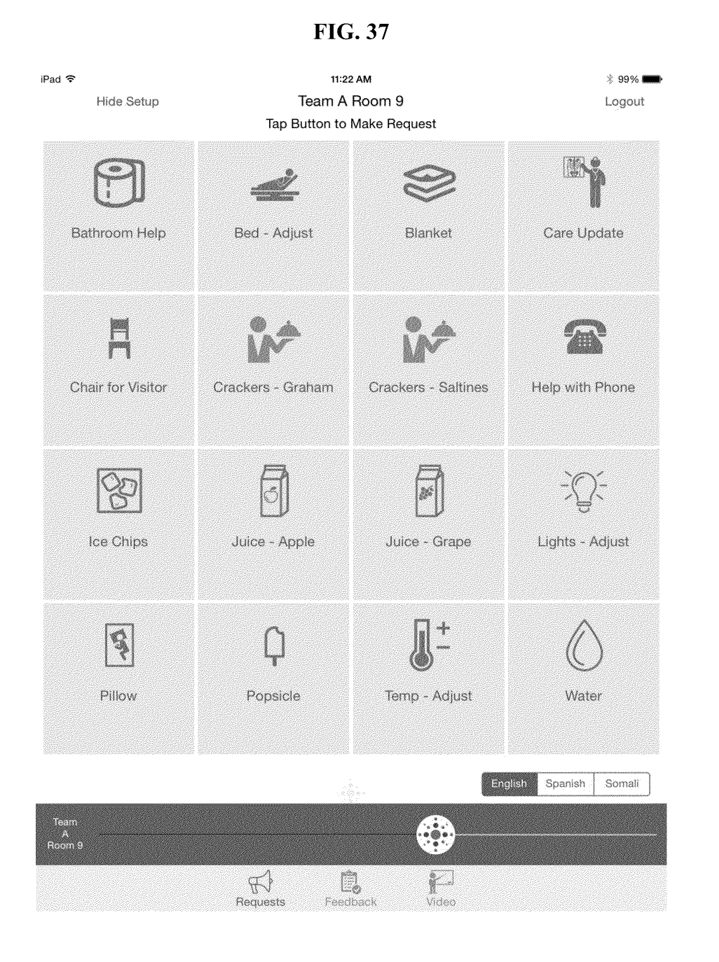

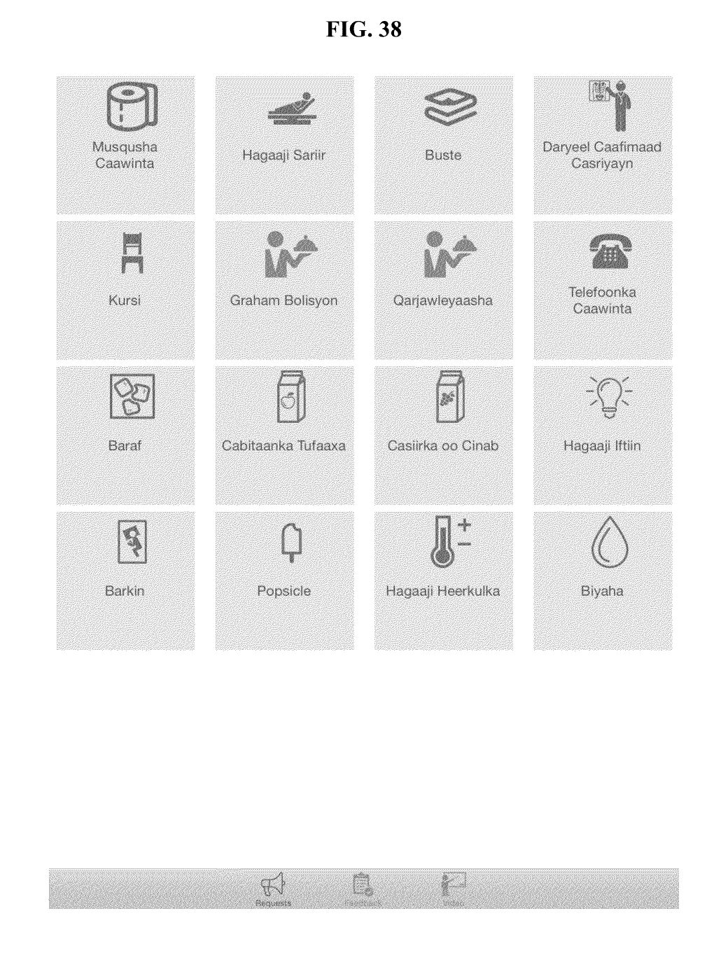

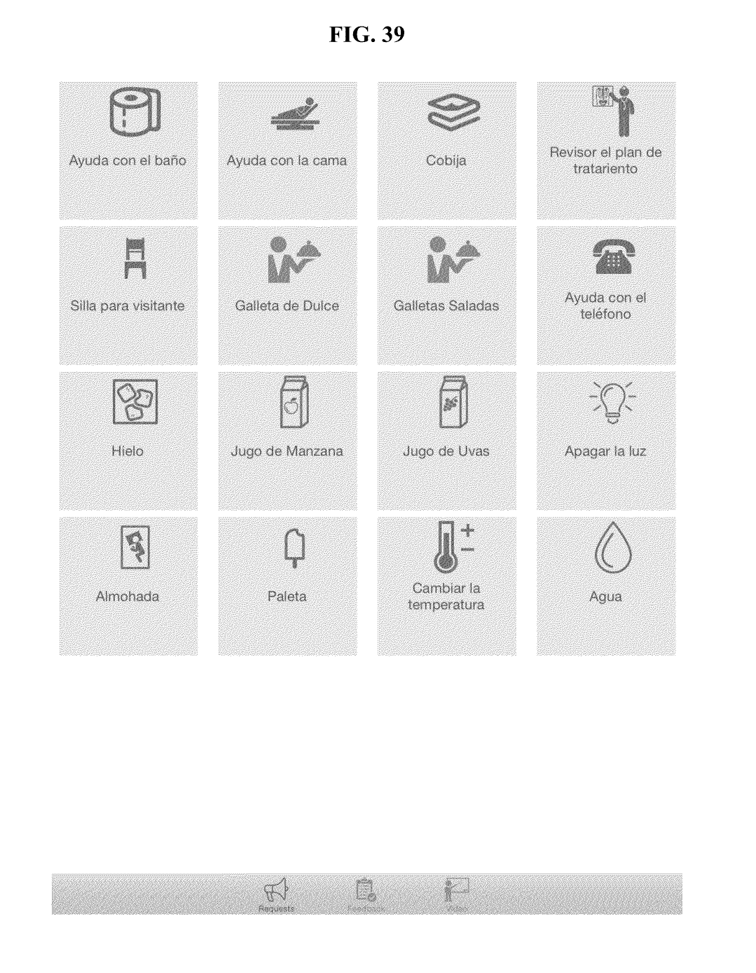

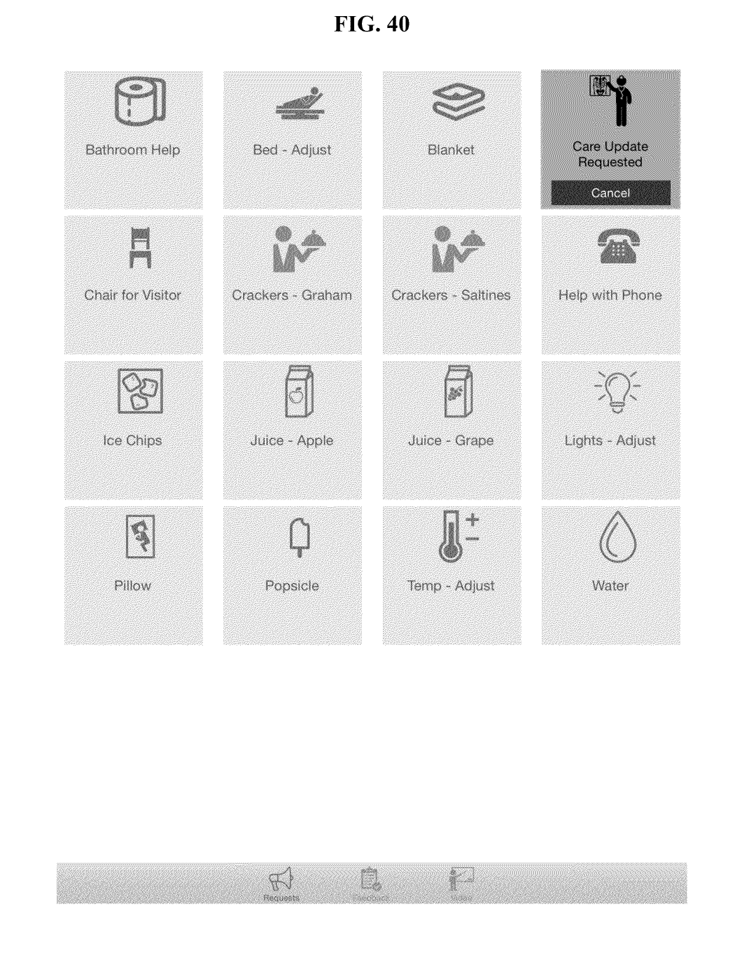

TV monitors may be used in patient rooms and staff hubs, and may be wirelessly connected to mobile devices using the system (for example, using Apple TV with Airplay) to display content from the mobile devices for shared viewing. Patient rooms may further include a device mount to secure or tether a mobile device to the patient room. In some embodiments, mobile devices such as tablets may be present in patient rooms for patient use. This may include patient education (for example, pre-loaded health and disease-management information and ED process and expectations), patient distraction/entertainment (for example, internet, pre-loaded apps, games, or puzzles, streaming radio, and/or videos), and communication with ED staff. Communication may be routed to the appropriate staff person or role for things such as pain management or basic requests such as water, blanket, or cleanup, among other things. An example patient request screen is illustrated in FIG. 37 This screen can enable a patient to quickly send a common request directly to the proper staff member and receive a notification when the staff member acknowledges receiving the request, as illustrated in FIG. 40. The patient request screen can be made available in other languages such as, but not limited to, Somali, as illustrated in FIG. 38 and Spanish, as illustrated in FIG. 39. The in-room tablet or mobile devices may have a wireless connection to TV monitors for staff and patient use.

A charging station may be used to keep devices such as smart phones and tablets charged, synched and secure (for example, Apple Learning Lab). The charging station may include locks or security. Printers or scanners may be used to provide hard copies of records or other documentation for patients and staff as needed.

Various types of users will benefit from use of the disclosed system and method, including physicians, nurses, charge nurses, techs, health unit coordinators, triage, consulting physicians (such as radiology, neurology, surgery, or others), patients, patients' families, nurse supervisors, hospital or ED IT, hospital or ED administration, lab or pharmacy workers, hospital admissions, and EMS staff. Each user's interfaces can be tailored to their role. Further, using the disclosed system for reporting will create metrics to help staff and management improve their performance. For example, detailed, immediate stroke response data for each specific case as well as comparison to recent history, averages, benchmarks, and goals will enable staff and management to see where improvement has occurred or where improvement is needed. In one embodiment, the data may include task volume trends for staff utilization analysis and system usage.

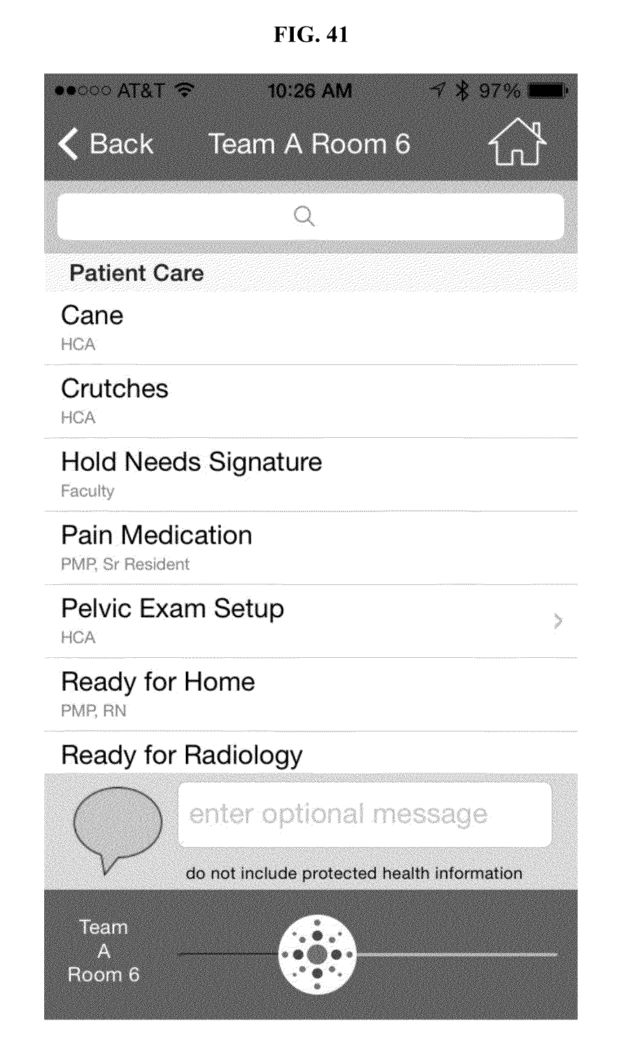

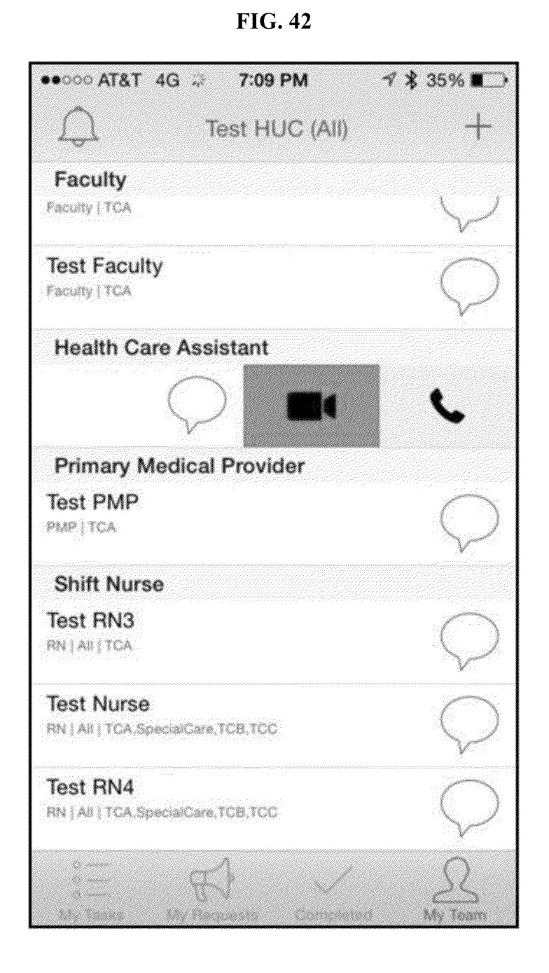

A major component of the invention is direct, secure communication on mobile devices in the form of voice, text, and picture or video messages. As an example, communication may be between and among ED staff, using a closed loop system with confirmation of communication sent/delivered/acknowledged. These communications may be related to requesting procedures, or providing instructions such as draw blood, clean room, and transport, as well as other common tasks related to clinical care, patient comfort, general communication, consults, language interpretation, etc. These will ideally be accessible via pre-populated lists with no typing required, but will have the ability to add text to request if needed, as illustrated in FIG. 41. Communication can include voice and video, as illustrated in FIG. 42.

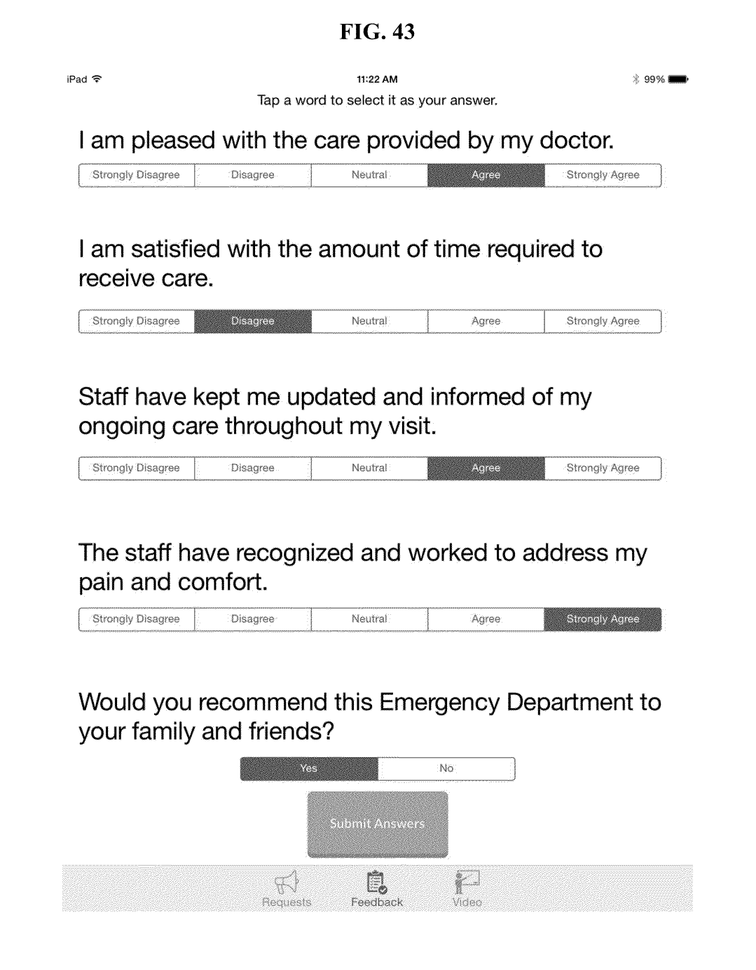

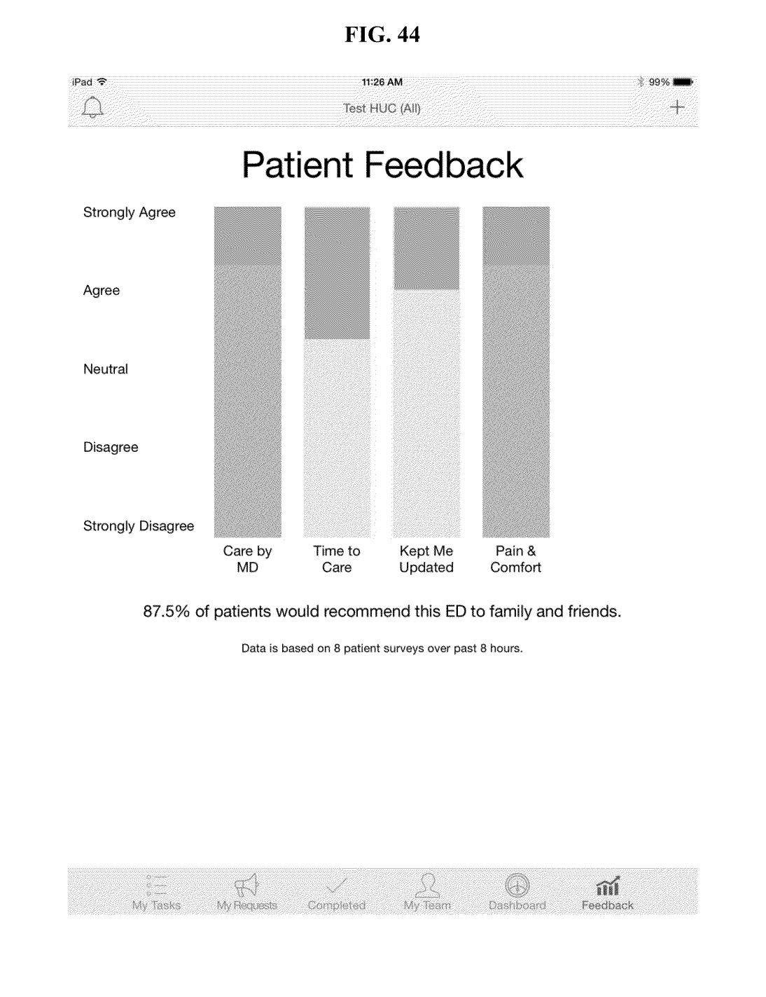

As a further example, communication may be between ED staff and a patient, and may relate to information such as notification of room availability or wait list, patients' requests for ED staff, care plan (steps in care process and current status); care team (including pictures of key staff assigned to care for patient), or discharge and follow-up instructions, among other things. In one embodiment, discharge and follow-up instructions could be sent via text message, automated or otherwise, and could have specific requests (such as: has stress echo test been scheduled?). In another embodiment, a patient can provide satisfaction ratings via a brief survey, as illustrated in FIG. 43, and staff can receive and view a real-time summary of patient responses, as illustrated in FIG. 44.

As a further example, communication may be between ED staff and other hospital departments, for example, lab, pharmacy or imaging. This communication may be used to request to review images, perform labs or fill medications, among other things. As a further example, communication may be between ED staff and consulting physicians. The invention allows for direct, immediate contact for consults with specialists, and eliminates the use of phone trees or call services to reduce wait time. As a further example, communication may be between a patient and their family or friends to provide information such as status updates.

In addition to direct communication, the invention features intelligent workflow management tools developed specifically for the ED environment. The tools may include a task list, order sets with role specific task assignment, and a timer or stopwatch, among other things.

As an example, the task list might include status and elapsed time, and notification of incomplete or delayed tasks. A user may use voice prompts for specific notifications or set expected completion time(s) for common tasks for comparison against actual elapsed time. A user's task list might also include the user's personal to do list, with room, name of requestor, and time since request. A user could also track tasks requests of others with status indicators, assignment, time elapsed and/or notification of completed tasks based on the user's preferences. A user would ideally have the ability to mark tasks as “high priority.” Lastly, a user would ideally be able to sort tasks by key metrics, for example, status, time, time since request or room number. A user could also review a list of tasks completed by the user, including time from request to completion, as well as a list of tasks requested by the user that have been completed (who, when).

The system may include order sets with role-specific task assignment, for example, lumbar puncture, stroke, sutures, or others. Tasks may also be auto-populated based on patient diagnosis. Components of each order set can be identified and requests can be routed to proper staff. A user may have the ability to add steps or tasks beyond the default set. Order sets may also include a sequence of steps for best patient care, location of equipment, and/or links to training or setup info and videos.

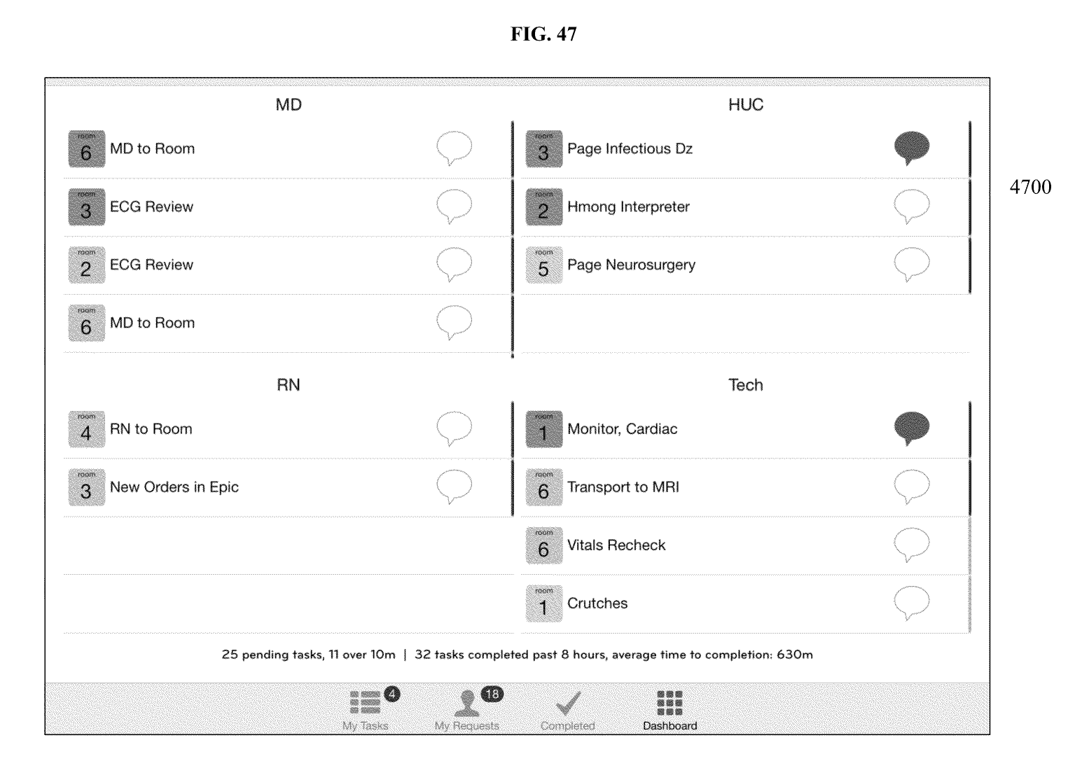

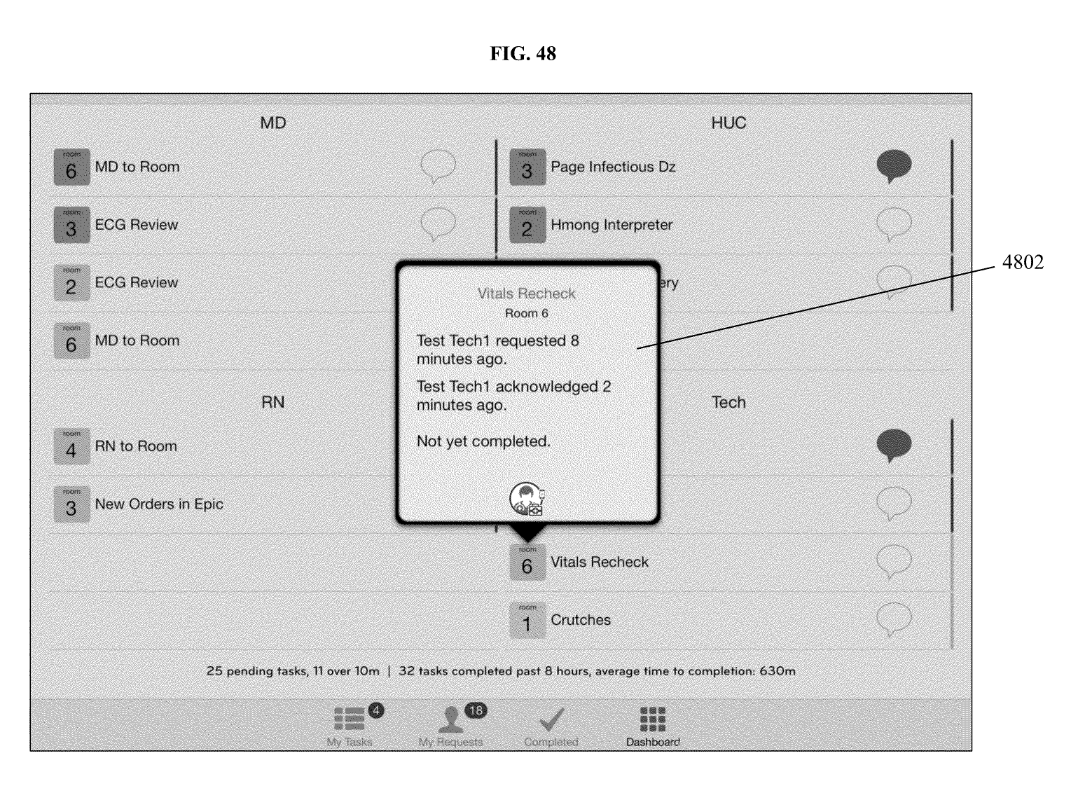

Another key component of the present invention is the dashboard 4700, one version of which is illustrated in FIG. 47. Using this feature, a user can see a “bird's eye view” of all tasks and the status of each task with regard to elapsed time, assigned/unassigned status, accepted/not accepted status, and grouping by role or room. Department-level metrics could also be provided such as, but not limited to, including total pending tasks for department/section, number of pending tasks outstanding for more than x minutes (ex. 10), total number of users, number of requests completed in last 8 hours, average time to completion, related text messages. When a task is selected in the dashboard 4700, details 4802 of that task such as when a task was requested, when the person whom it was requested from acknowledged it, and if and when it was completed, are displayed, as illustrated in FIG. 48.

A user has the ability to reassign tasks as needed. The dashboard also provides a user with web access. Key users of this feature may be, for example, charge nurses, supervisors, and health unit coordinators, but in some embodiments the dashboard is viewable by all users. As an example, a health unit coordinator may use the dashboard to follow up on delays. The dashboard may also be used to set and view staff assignments to room or set and view staff status settings, among other things. The dashboard may be accessible from a mobile device, a desktop computer, or may be web-based.

In some embodiments, the invention captures patient information such as indoor location (or room assignment), name, gender, age, vitals (for example, temperature, blood pressure, heart rate and oxygen level, among others), chief complaint, medical history, primary care provider, socioeconomic information, allergies, medications, and lab and radiology results. The invention also includes visual depiction of physician references for use by other staff members, for example, technicians and nurses. This feature is intended to expedite setup and reduce rework. For example, this feature may be used to expedite procedure setup by showing pictures of required setup and details to a user. This feature may also include notification settings.

The invention may also include a staff view to indicate which users are logged in to the system and their availability (for example, “available” or “do not disturb”). This might include a list of all ED staff with work status and shift assignment, hospitalists, and a populated/managed contact list of on-call providers. The staff status view can be integrated with directory and staffing systems. A user has the ability to send communication to staff members directly from the staff view.

In some embodiments, the system may be set up for direct communication with patients' mobile devices to notify patients of wait times or delays, notifications such as ready to take to ED room, or diagnosis and follow-up information in an electronic format. There may also be integration with patient data, for example, imaging via Dicom Grid link, vitals and EKG results via Spacelabs link, or lab results.

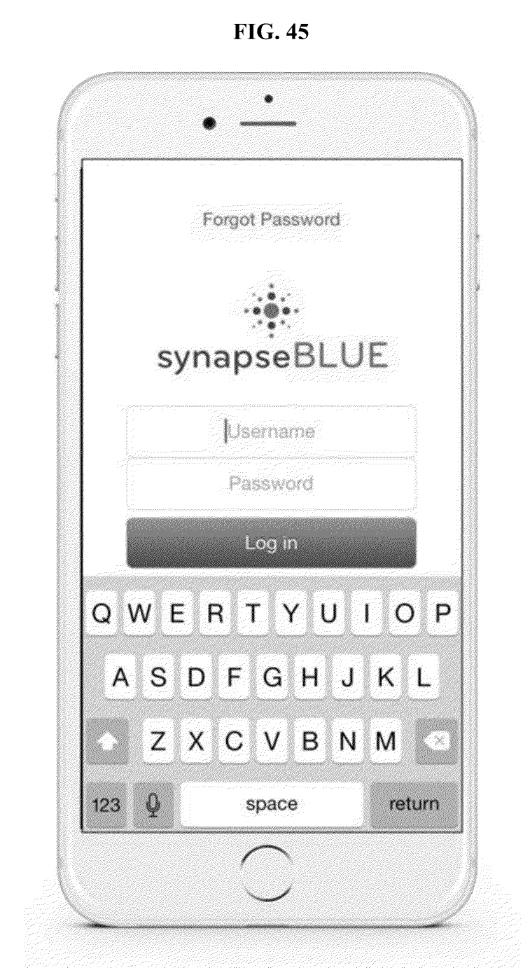

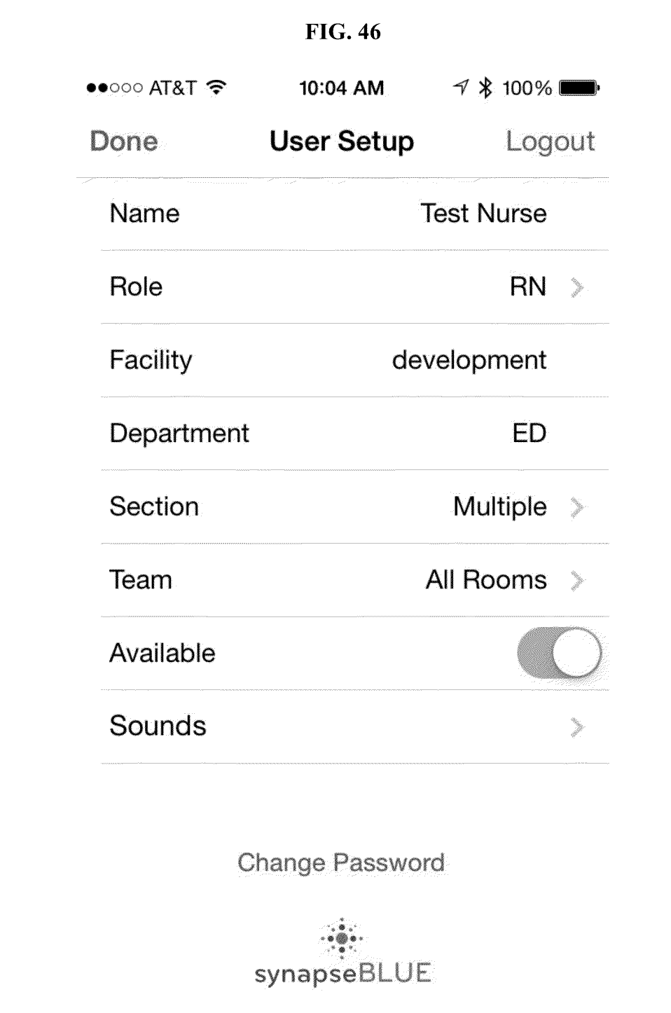

Each user or staff member can choose or be assigned a secure login to access the system. One embodiment of the login screen is illustrated in FIG. 45 and one embodiment of the user setup screen is illustrated in FIG. 46. Upon logging in each day, users may be able to enter their shift information, such as hours, site or facility, and pod or room assignment. The system may include embedded links to useful patient education materials such as visual presentation of anatomy and/or procedure, disease management (for example, diabetes management or smoking cessation), and application recommendations, and may be presented in multiple languages. Using the invention, care providers will have quick access to common medical reference applications. The system can be integrated with, or linked to, relevant applications (for example, Epocrates) with a single sign-on or login. The system can be tailored to the needs of the role of each user, and may include utilities such as rulers or medical calculators. Additional content may be added as needed, for example, hospital-specific policies.

The invention incorporates client-developed staff education materials, such as procedure training videos, reminders to review department communication with optional acknowledgement requirements, and practice guidelines for adequate reimbursement documentation. This may also include department protocols and equipment location and proper use. In-room devices can be configured to provide patient distraction or entertainment media. For example, the system may include pre-loaded content such as magazines, videos, or web access. The patient distraction or entertainment media may be age specific and restricted for adult content, and can further include games, puzzles, drawing activities, or music via streamed radio stations.

Based on completed tasks and diagnoses, the invention provides targeted reminders for reimbursement coding. This may include reminders to users to document procedures. This is not intended to dictate which specific coding to use.

The invention can be integrated with emergency medical record (EMR) systems to pull key patient information, including data most relevant to emergency care, from the EMR systems. This functionality may include notification of key results reported or input into EMR and order entry at point of care. This may also include direct input and monitoring of orders, notification of task completion directly from EMR, and the ability to view patient health information, for example, medical record (for example, medications or allergies), history (for example, past disease, procedures) and/or lab results.

In order to provide value across many types of ED organizations and individual users, the invention offers numerous configuration options and preference settings, such as type of notification for certain events (for example, tone, voice, flashing lights, and others), accessibility features like font size or volume, and expected task times.

In some embodiments, the system includes remote monitoring of medical equipment. The system can be paired with existing providers, for example, Spacelabs for vitals, via embedded links, and can provide real-time data, notification of abnormal readings and integration with wearable sensors (ex. Angel Sensors) providing pulse, temp, oxygen saturation, and other data.

In some embodiments, the invention will indicate staff and patient location based on geofencing functionality. Staff users may receive notifications of patient-assigned device movement, for example, to indicate a patient move from ED to CT. This functionality may also include red room response tracking, for example, speed and proper personnel. Location of users may be available from the dashboard of the system, which can also provide notification if proper personnel are not all present. In an ideal embodiment, the system can also create a “no interruption” zone and automatically set physician status to Do Not Disturb based on location. This feature can be user configurable.

The following is a description of one example of the process by which the present invention may be used. Upon arrival at the ED, a patient enters the Triage process to assess the criticality of their situation and the proper clinical response. Registration of the patient is notified within the system, and technicians are notified immediately to get an EKG reading (if needed). The remaining patient care typically takes place once the patient is taken into an ED exam room. Using the system, patient care is improved in the ED through, for example, quick communication among care staff; workflow/task management such as requests, to do lists, status, elapsed time, and automated delay notification (based on time settings); medical reference; patient education; patient distraction/entertainment; and physician preferences (for example, procedure set-up).

After receiving care in the ED, the patient may be discharged, sent for a procedure (for example, surgery), or admitted as an inpatient. At this point, the invention provides the ability for the user to directly communicate with the staff that is needed to complete the appropriate process. This may include a pharmacy notification, discussion with the physician who admits the patient, patient transport, or a request for room cleaning After the patient is discharged, care providers can use the invention to follow up with patients as needed in hope of reducing return visits to the ED.

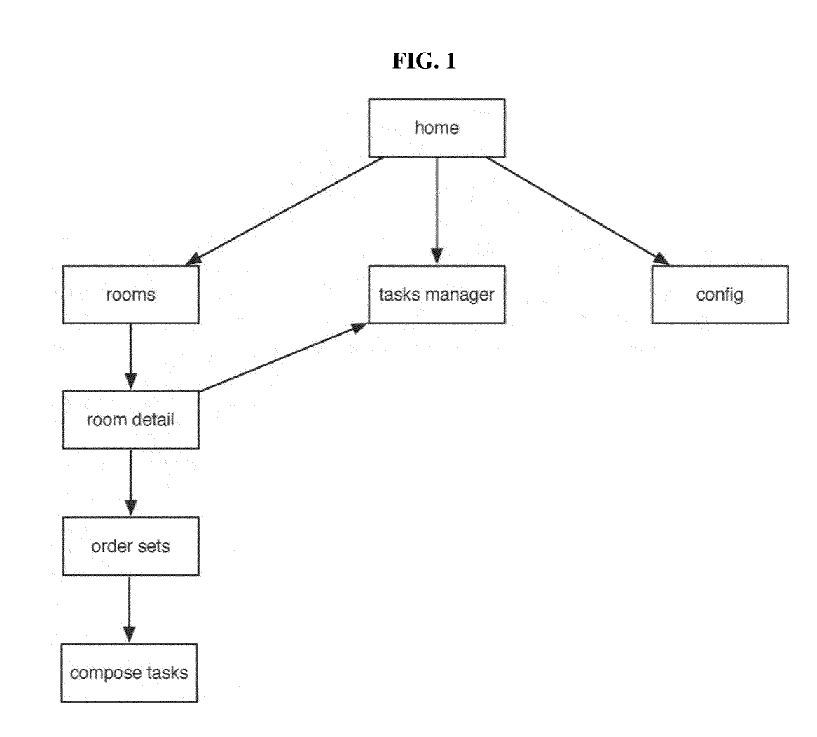

Referring to the drawings, FIG. 1 is a diagram illustrating functions of one example of the mobile interface according to one embodiment of the present invention. In this example, the interface includes a home screen, through which a user can view rooms, a task manager, or configuration. If a user selects to view a room, they can then view room details, order sets, and compose tasks for that room or patient.

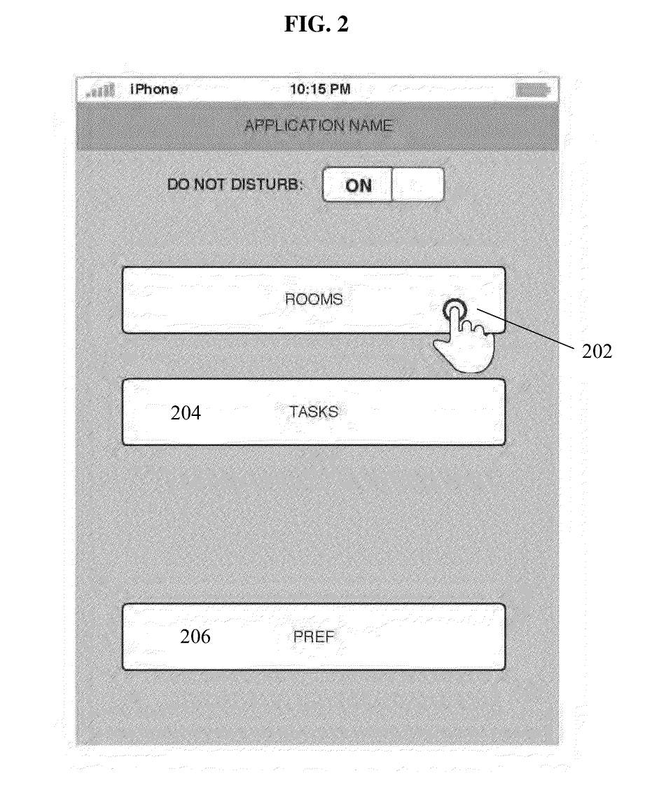

FIGS. 2 through 22 are example graphical user interfaces according to one embodiment of the present invention. Mobile computing devices used in accordance with the invention may include a touch screen, allowing a user to perform various tasks by tapping to select or interacting otherwise with the touch screen, examples of which are described herein.

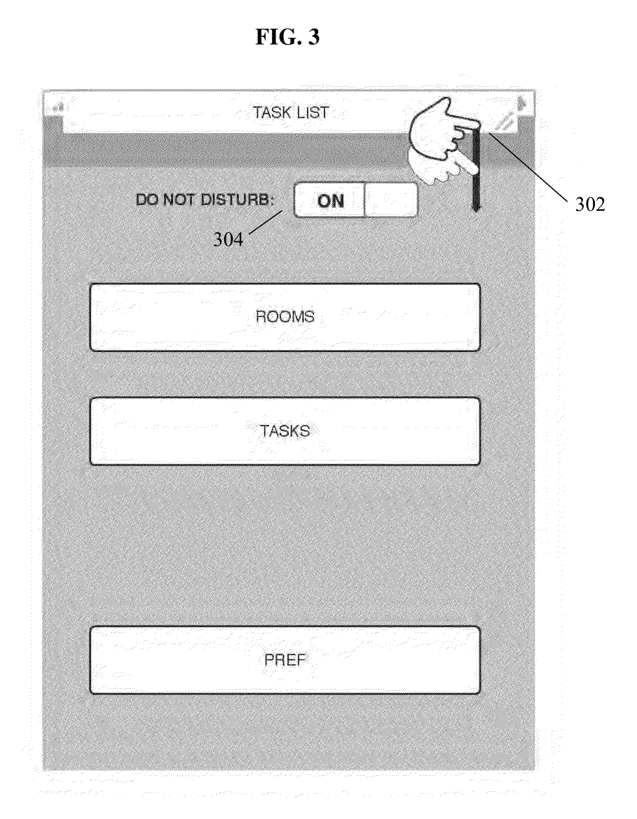

FIGS. 2 and 3 are example graphical user interfaces illustrating the home screen according to one embodiment of the present invention. As illustrated in FIG. 2, a user may tap the “ROOMS” button 202 to select and go to the rooms interface. A user may also have the option to go to the task manager 204, or access a configuration or preferences interface 206 to modify system level settings such as size of on-screen text and alert sounds. As illustrated in FIG. 3, a user may flick down on the touch screen to access the task list 302. Notifications may be listed from most recent at the top. A user may toggle their “do not disturb” status 304; in the example shown in FIG. 3, the user's “do not disturb” status 304 is set to “ON.”

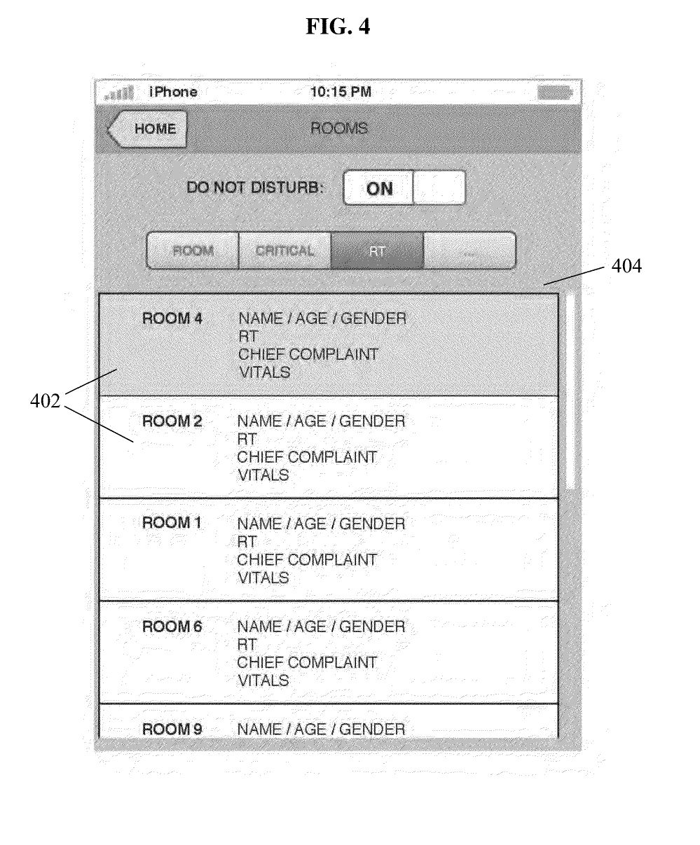

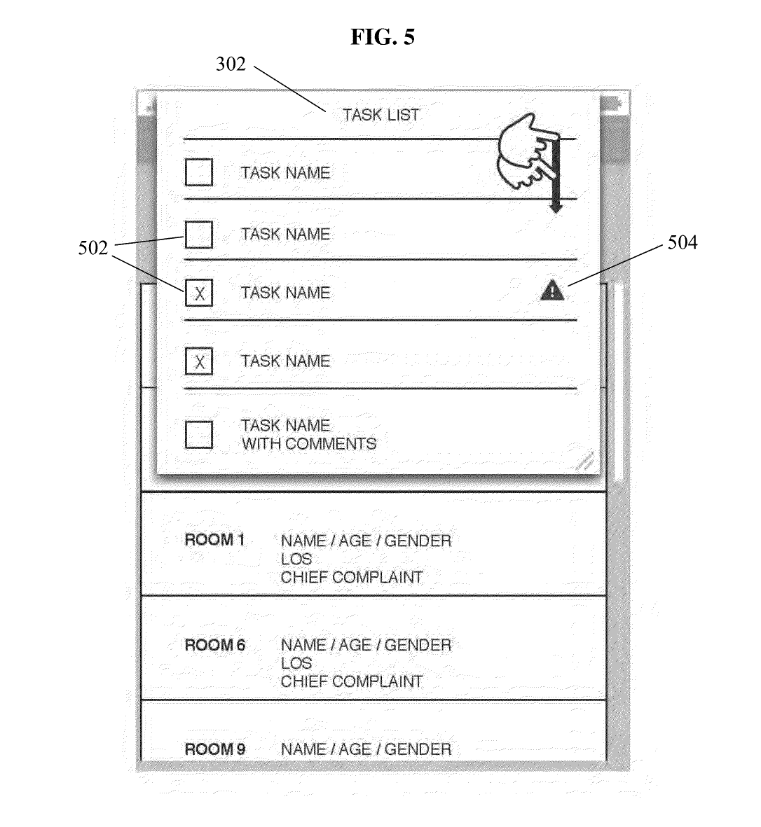

When a user selects the “ROOMS” button 202, they are taken to the rooms interface, as illustrated in FIGS. 4 through 7. In some embodiments, room tabs 402 may be color-coded based on acuity. Room tabs 402 comprise a room list 404, through which a user can scroll to view or access a specific room tab. Each room tab 402 may include basic patient information such as name, age, gender, room time, chief patient complaint, and patient vitals. FIG. 5 shows an example of the task list 302 expanded. The task list 302 may include check boxes 502 to indicate whether a task has been completed. The task list 302 may further include a critical task icon 504 next to tasks that are to be given higher priority over other tasks.

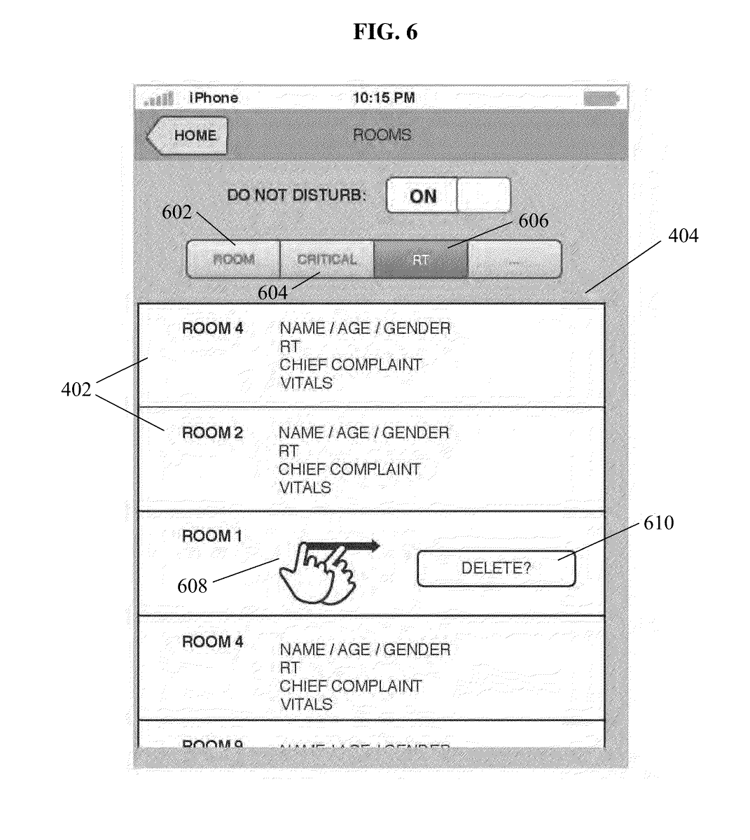

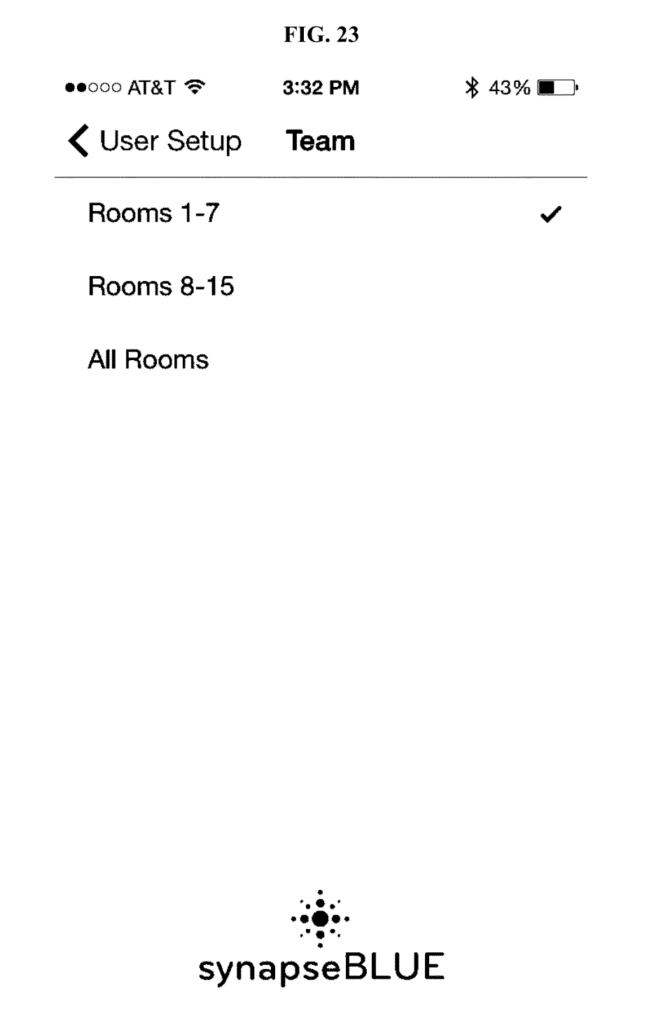

Referring to FIG. 6, a user has options for sorting rooms on the room list 404, for example, by room number 602, by critical task 604, or by room time 606. As an example, when sorting by room number 602, the room tabs 402 are numerically listed; when sorting by critical task 604, rooms with critical tasks appear at the top; when sorting by room time 606, the longest room time(s) appear at the top. In some embodiments, a user can swipe 608 across a room tab 402 to delete the room, and a confirmation button 610 will appear before the room is deleted. A user can also select a group of room assignments in order to filter task requests, as illustrated in FIG. 23.

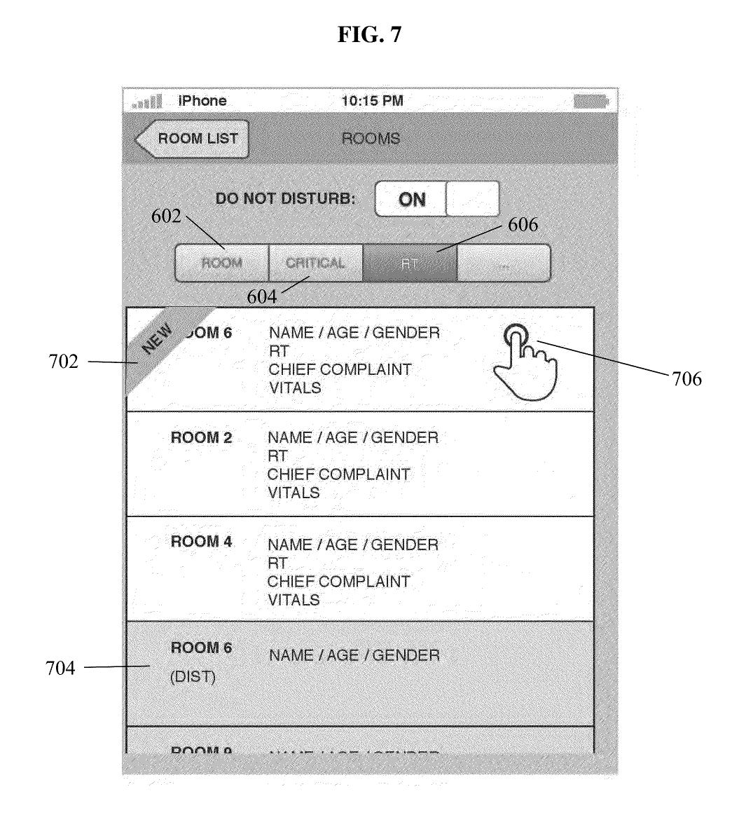

Referring to FIG. 7, newly added rooms may be indicated by a new room badge 702. Discharged rooms 704 may be marked as discharged, for example, appearing in a darkened color, but may remain on the room list until deleted by the user. As illustrated in FIG. 7, a user may tap 706 a room tab to access the specific room's interface.

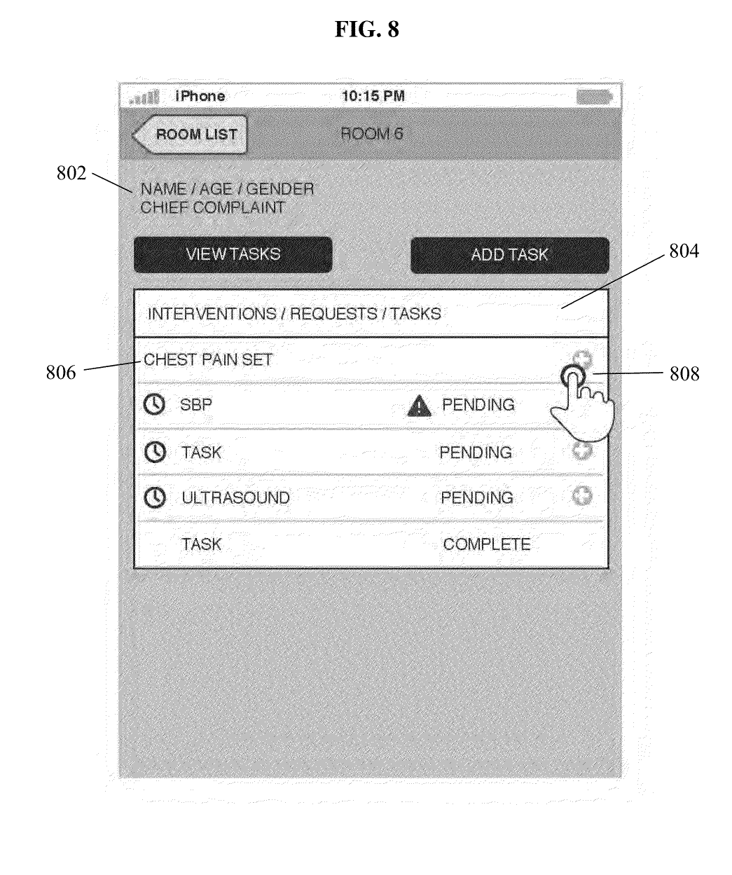

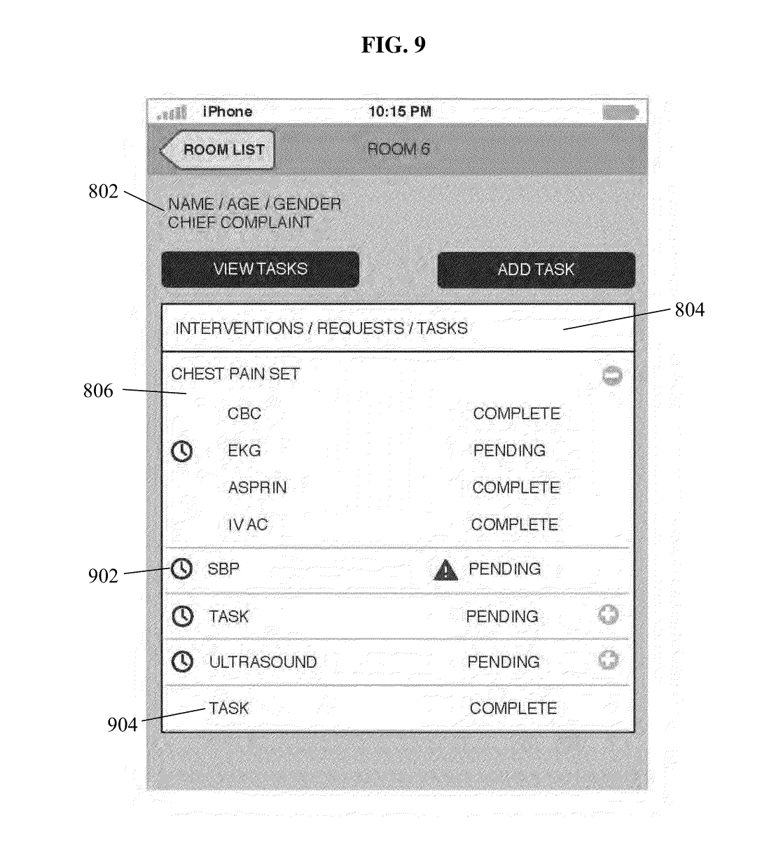

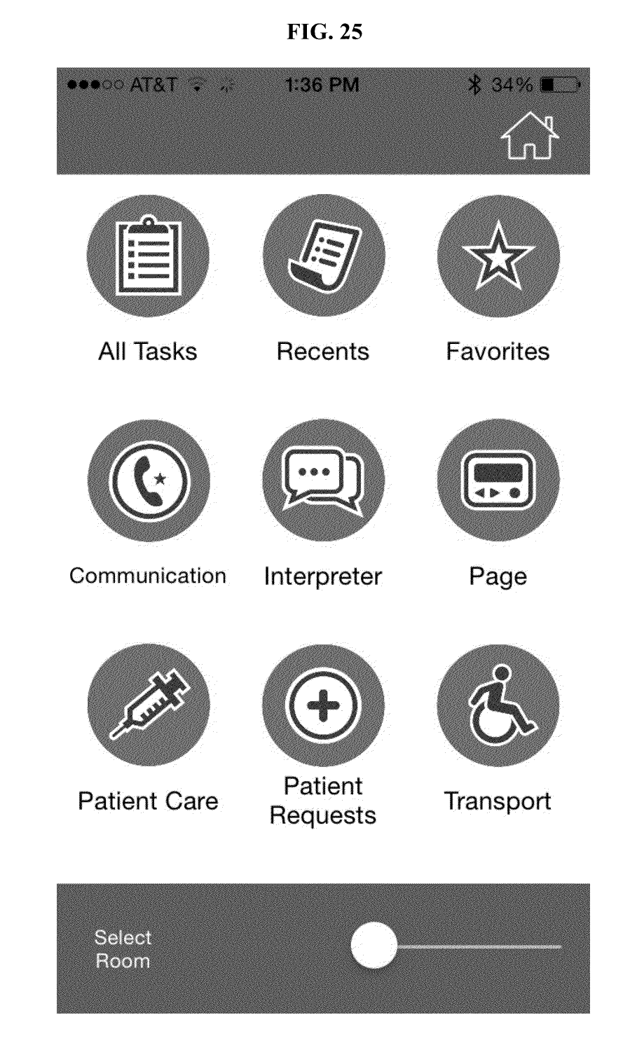

An example room interface is illustrated in FIGS. 8 through 10. In this example, the room interface includes patient information 802, such as name, age, gender, and chief complaint. The room interface may also include lists 804 of interventions, requests, and tasks, among other data. The room interface further includes order set(s) 806 associated with the specific patient, comprised of a task list for the order set. The user can tap 808 the order set 806 to open or expand the task list for the order set. An expanded order set 806 is illustrated in FIG. 9. When expanded, the order set indicates to a user which tasks are included within the order set. A clock icon 902 may be present to indicate the time elapsed since each task was ordered. A user may have the option to add a custom task 904 to the order set 806. In this example, the custom task 904 does not have a timer. However, in some embodiments, the custom task 904 can have a timer. Another example of a room interface is illustrated in FIG. 25.

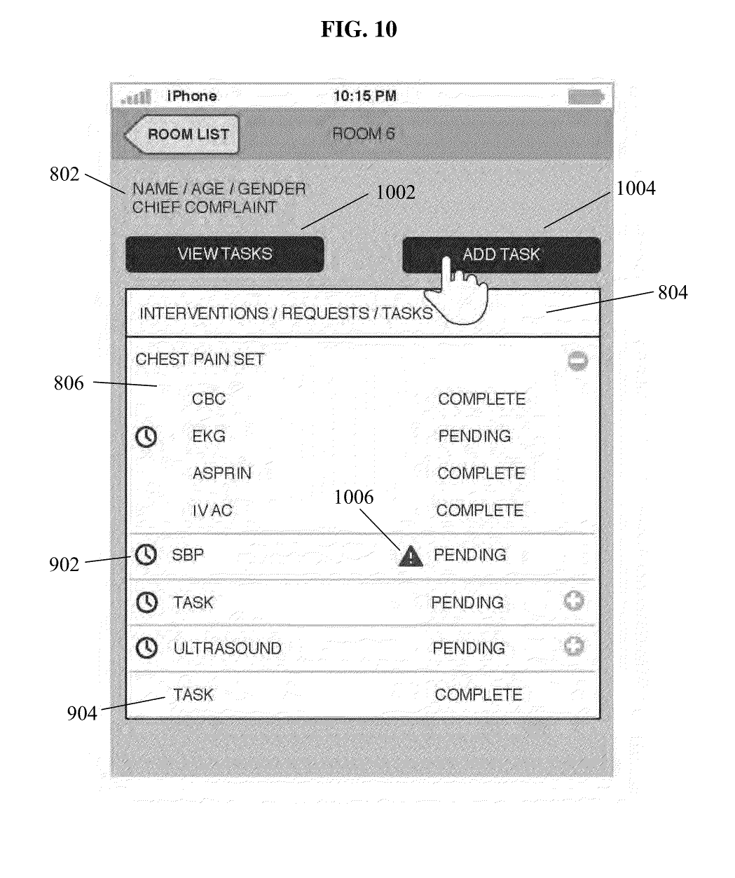

Referring to FIG. 10, while in the room interface, a user can access a task manager and view tasks for the selected room 1002 and order additional tasks 1004. Critical tasks within the order set 806 may be indicated or flagged by a critical task icon 1006, as described in reference to FIG. 5. As an additional feature, tasks assigned to a given room will only be routed to staff assigned to that room.

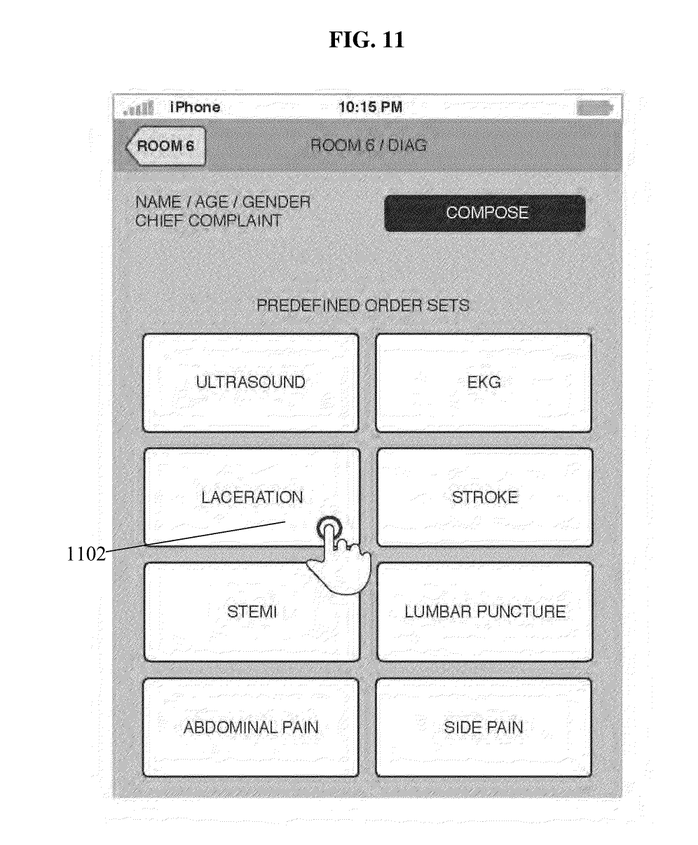

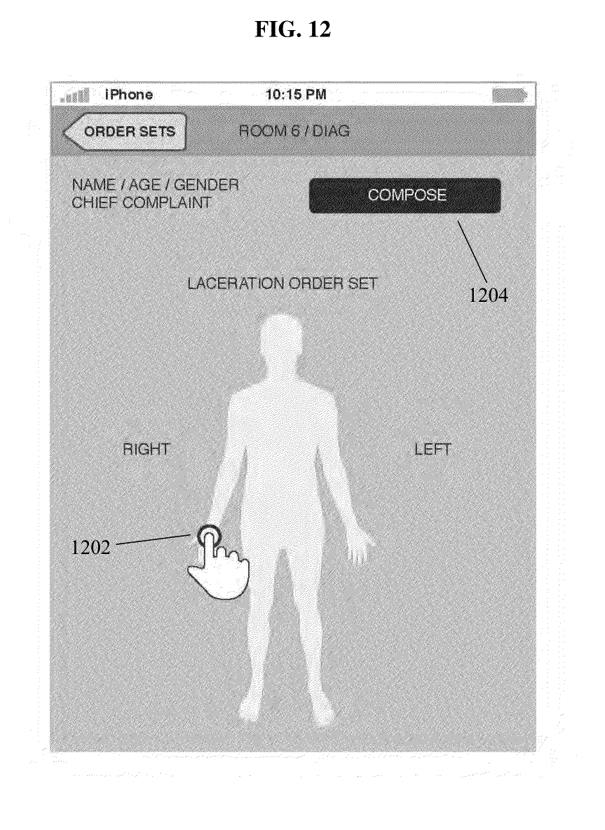

The presently disclosed system may include predefined order sets, as illustrated in FIG. 11. These may include order sets for procedures such as ultrasound, EKG, or lumbar puncture, and/or medical conditions such as laceration, stroke, STEMI, abdominal pain, or side pain, among others. In one example, a patient has a laceration located on their right wrist. An ED staff member would select the order set for laceration 1102. Selecting laceration 1102 brings the ED staff member to the screen illustrated in FIG. 12, wherein the ED staff member can select the location 1202 of the laceration. The ED staff member could then select to finish and compose tasks 1204.

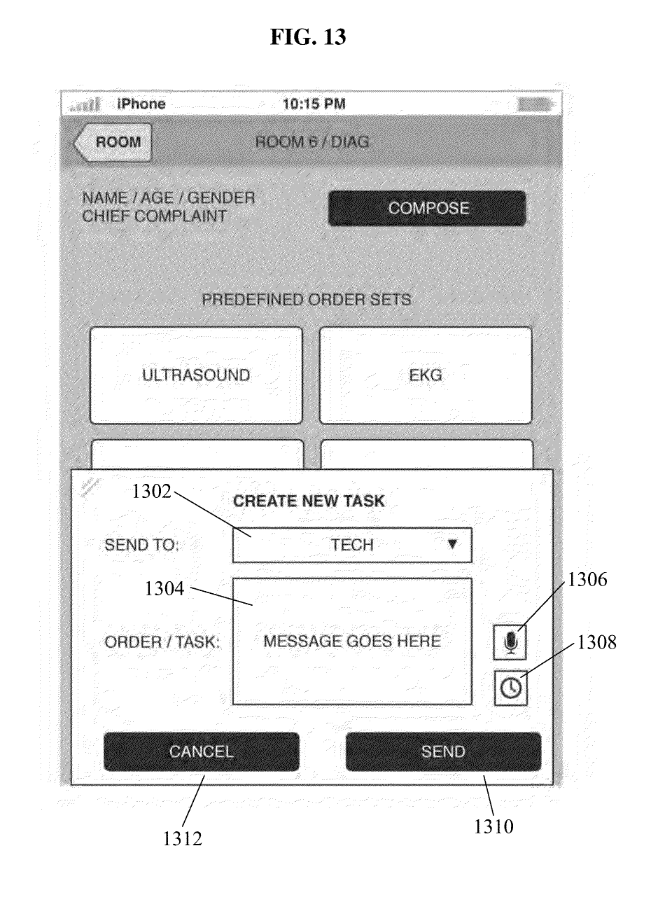

FIG. 13 illustrates an example interface wherein a user can create a new task. In this example, the user can select a system user from a pre-populated drop down field 1302 containing a list of all members of the user's medical facility. The order or task can then be entered into a free text entry field 1304. The new task creation interface may include options for voice recognition 1306 or to set a timer for the task 1308. Once the task is entered, the user can select to send the task 1310 or delete or cancel the task 1312 if it is no longer needed.

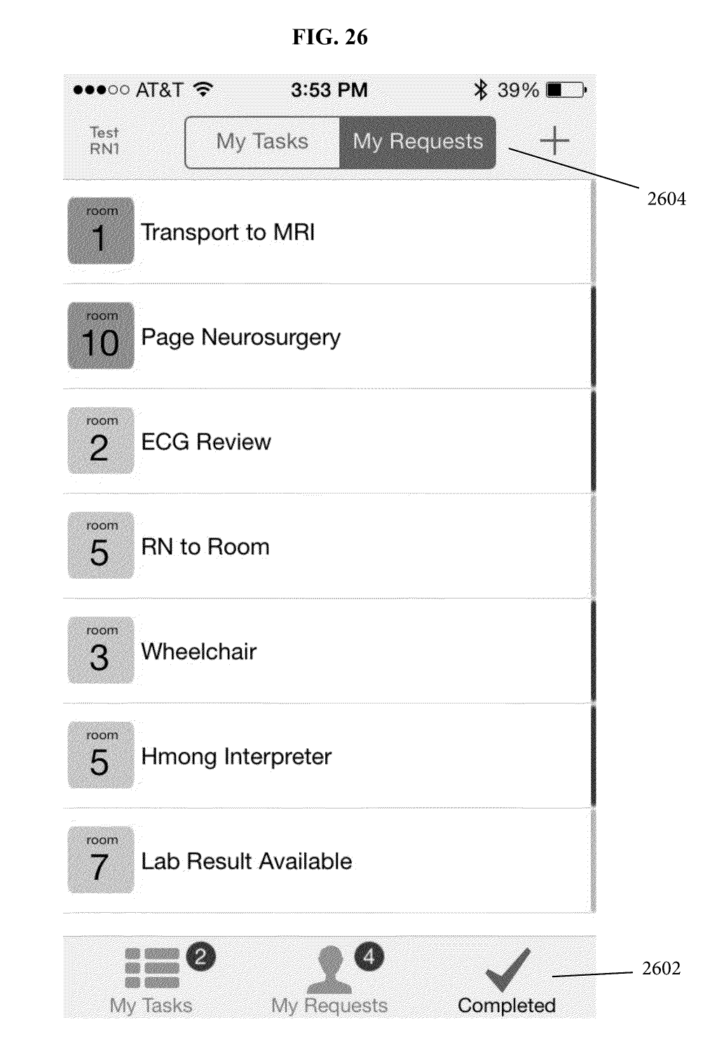

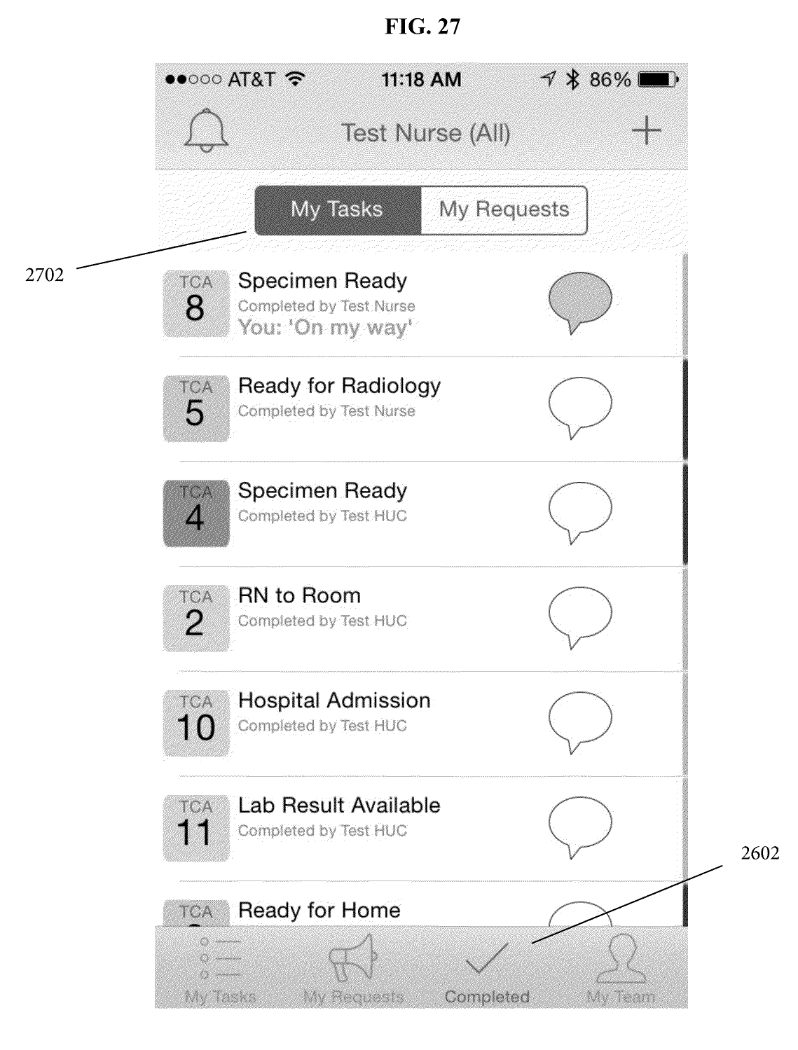

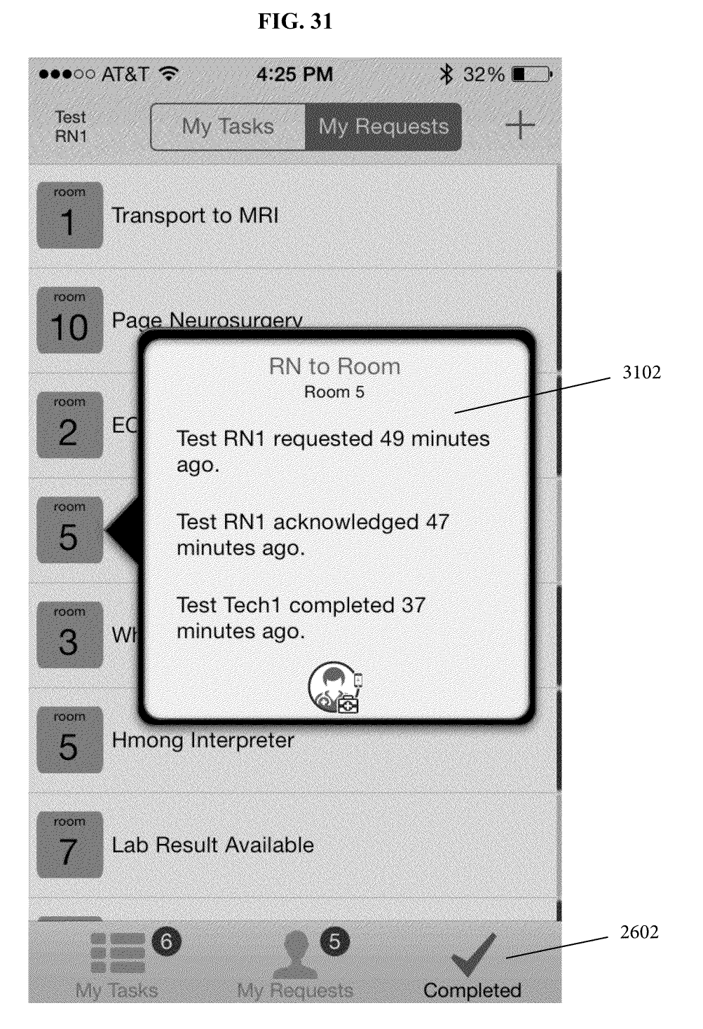

By selecting the “Completed” button 2602 and the “My Requests” tab 2604, a user can view his or her task requests that have been completed by others, as illustrated in FIG. 26. A user can also view tasks that he or she has completed by selecting the “Completed” button 2602 and the “My Tasks” tab 2702, as illustrated in FIG. 27. Within the “My Requests” tab 2604, a user can view the details 3102 of a completed task such as when a test was requested, when it was acknowledged, and when it was completed, as illustrated in FIG. 31.

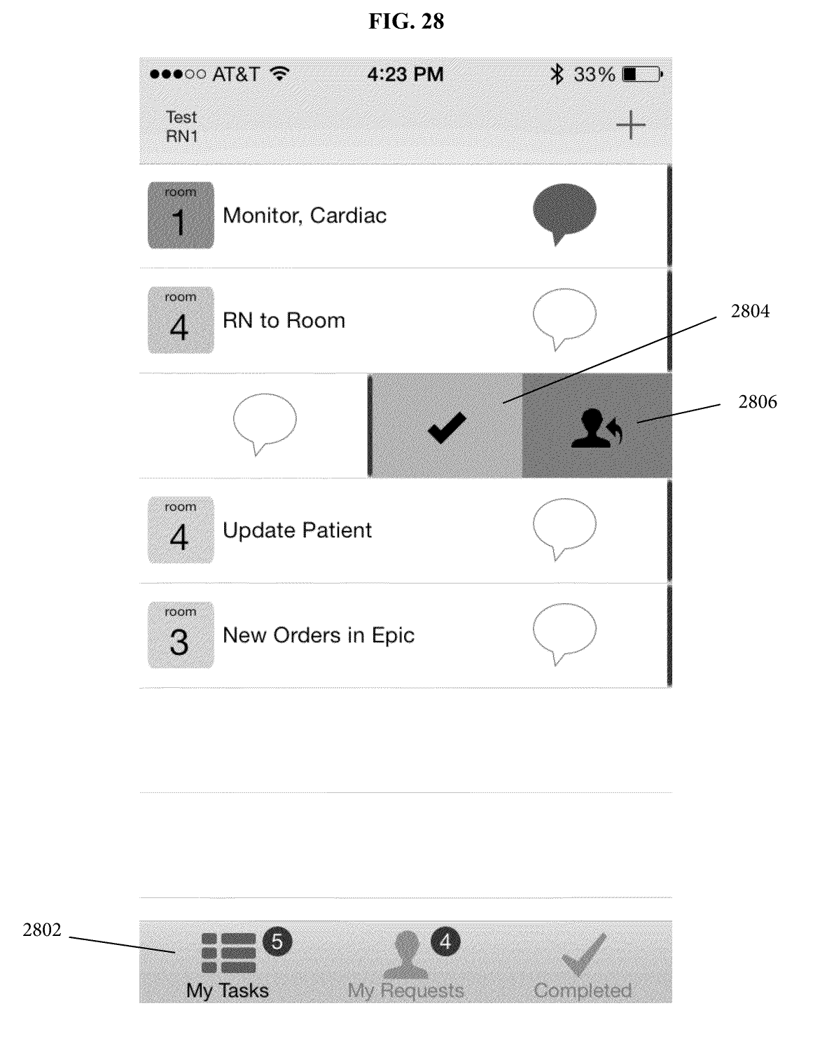

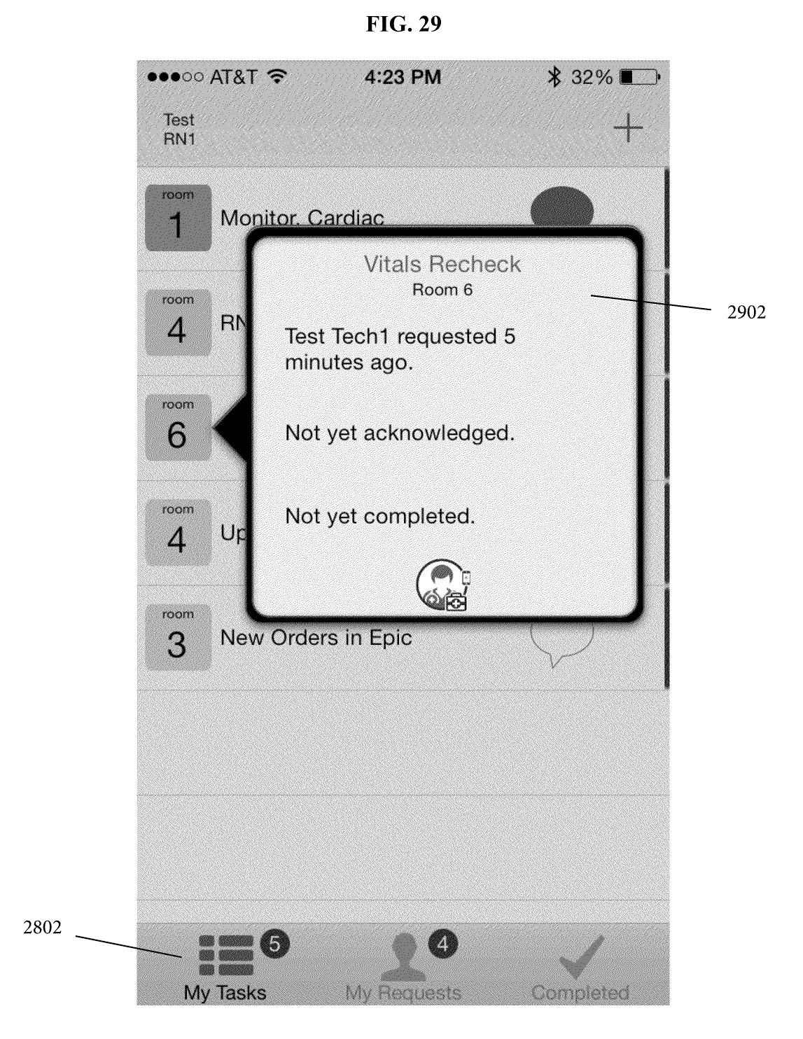

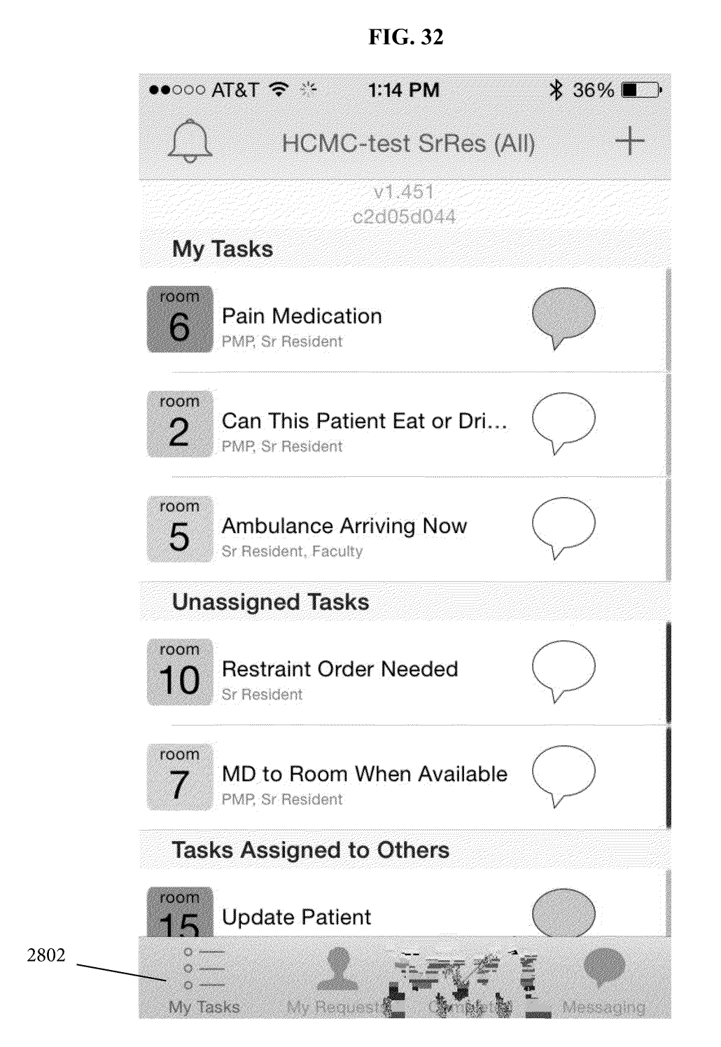

After selecting the “My Tasks” button 2802, as illustrated in FIG. 32, a user can see tasks that have been assigned to his or her role and rooms. To mark a task as completed or to assign a task, a user can select the “My Tasks” button 2802 and select a task to open up the ‘check’ option 2804 or ‘assign to’ option 2806, as illustrated in FIG. 28. After selecting the “My Tasks” button 2802, a user can also request further details 2902 regarding a task such as when the task was requested, when it was acknowledged, and if and when it was completed, as illustrated in FIG. 29.

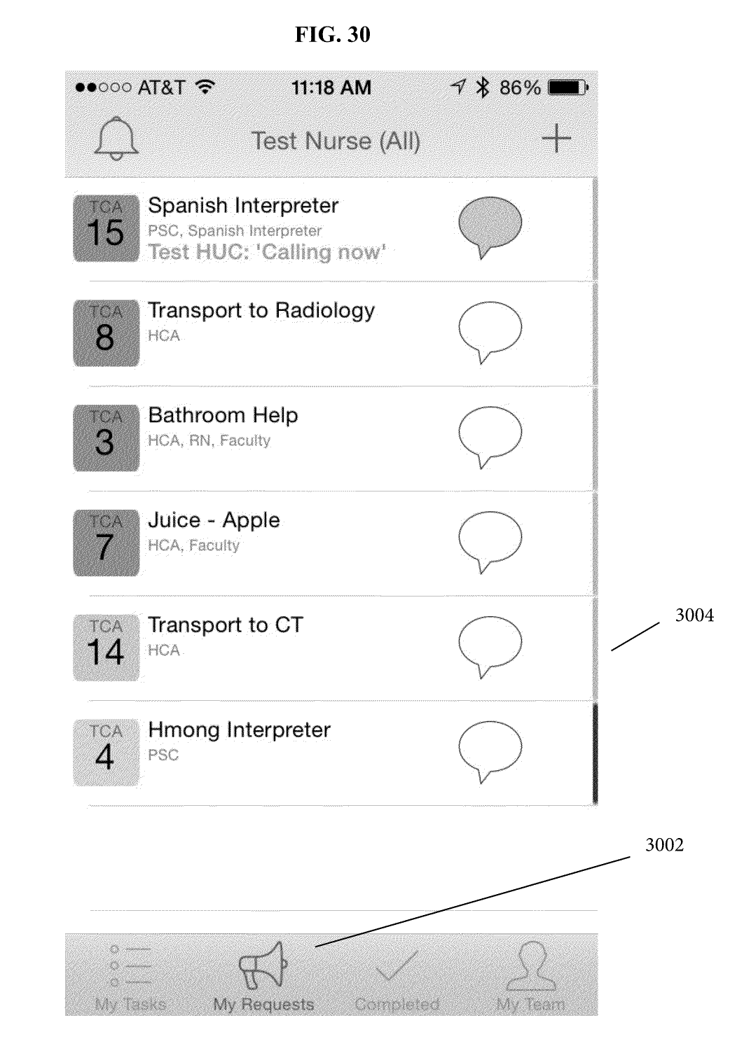

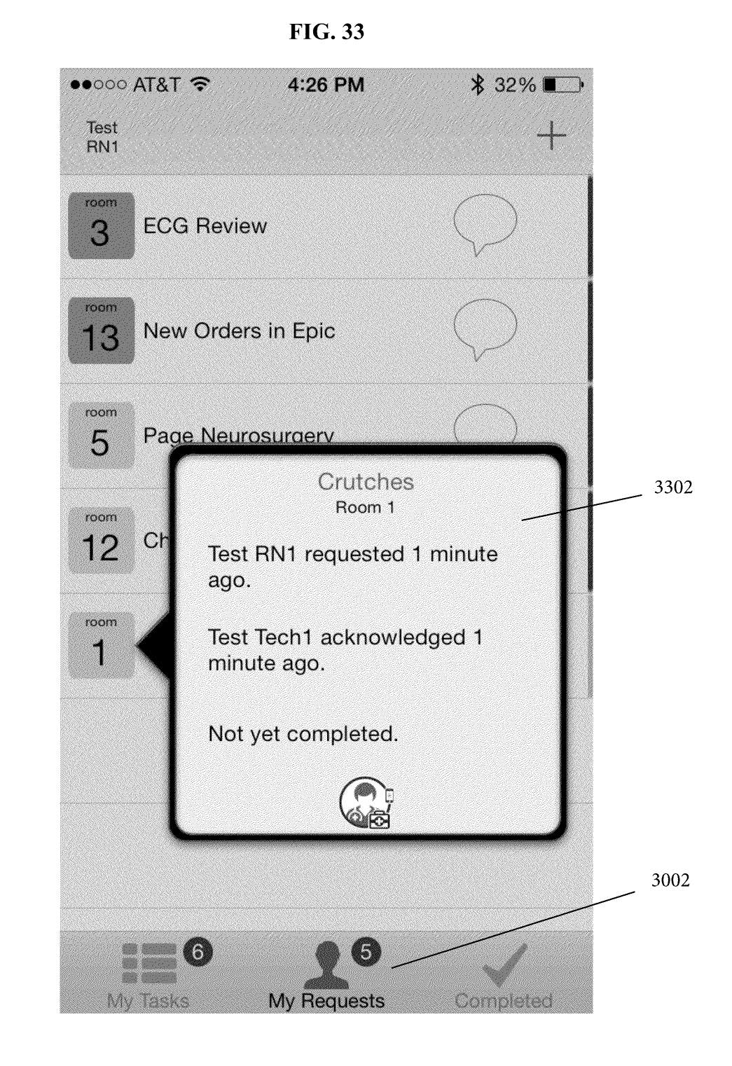

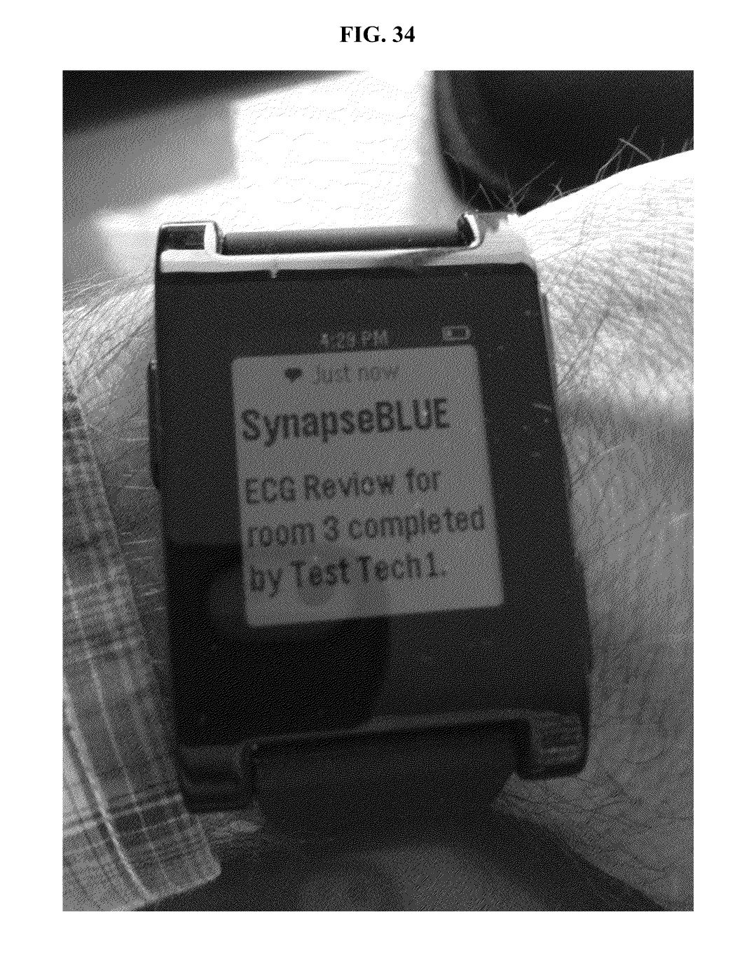

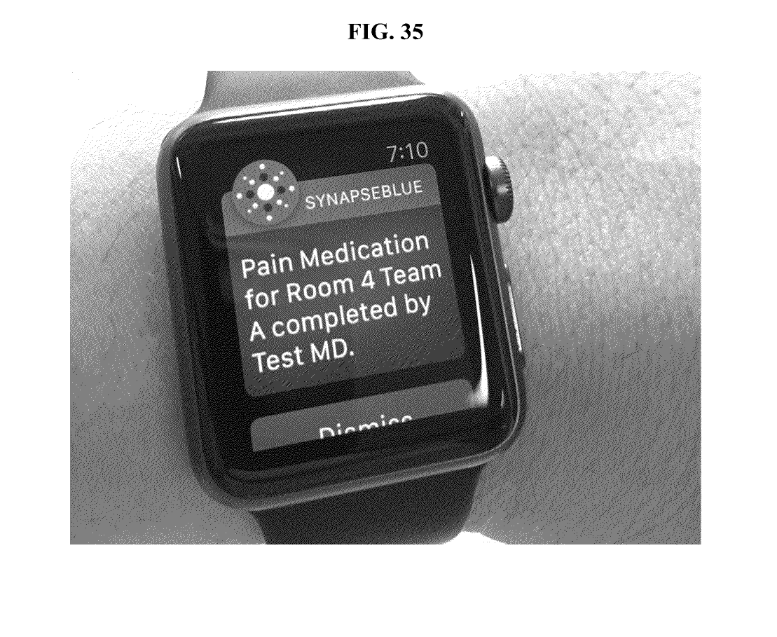

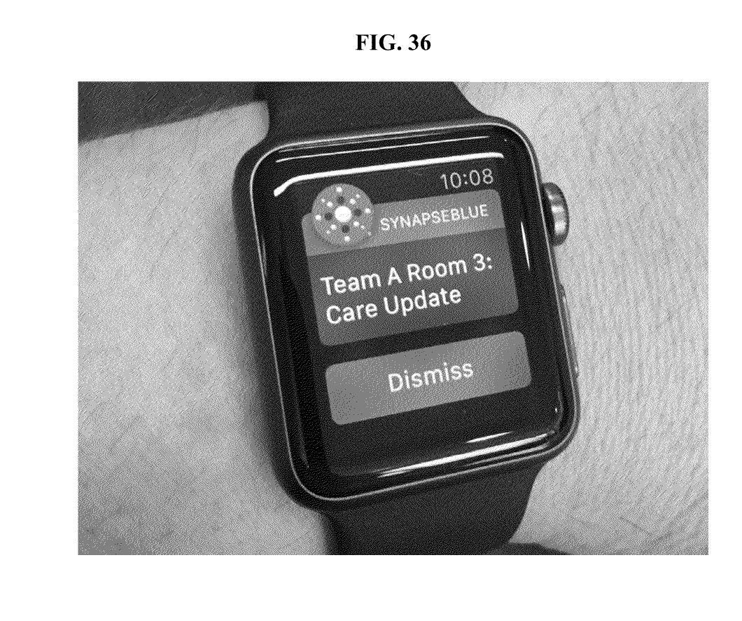

By selecting the “My Requests” button 3002, a user can view pending requests, as illustrated in FIG. 30. In one embodiment, a specific color, such as green, for a bar 3004 associated with each task indicates if a task has been accepted. A user can also view the details 3302 of a requested task such as when it was requested, when it was acknowledged, and if and when it was completed, as illustrated in FIG. 33. Once another person completes a task, a user can be notified through, for example, a Smartwatch such as, but not limited to, Pebble or Apple Watch, as illustrated in FIGS. 34-36. In addition, a Smartwatch can be used to directly and discreetly complete simple interactions such as accepting a task or indicating it as complete.

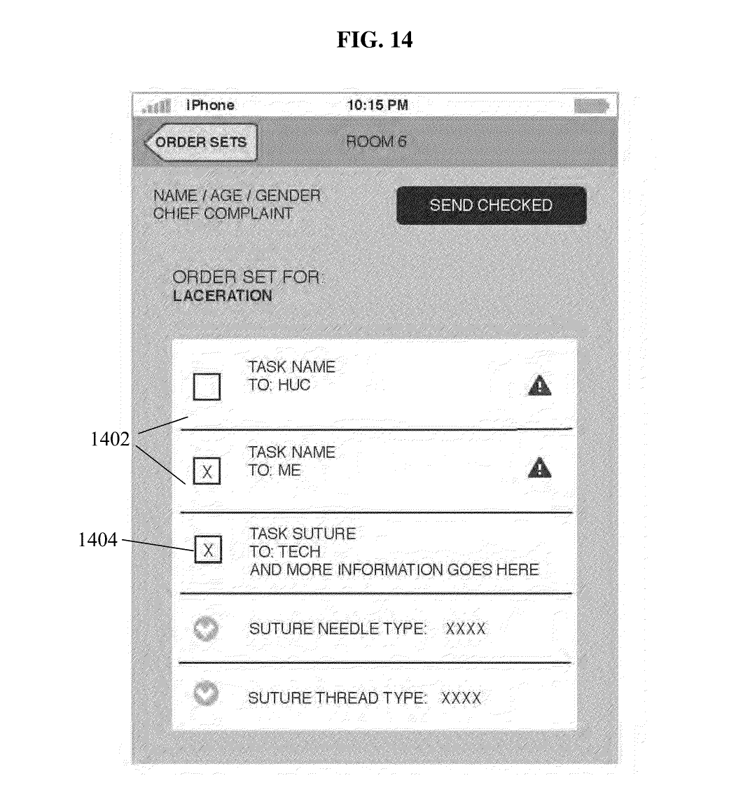

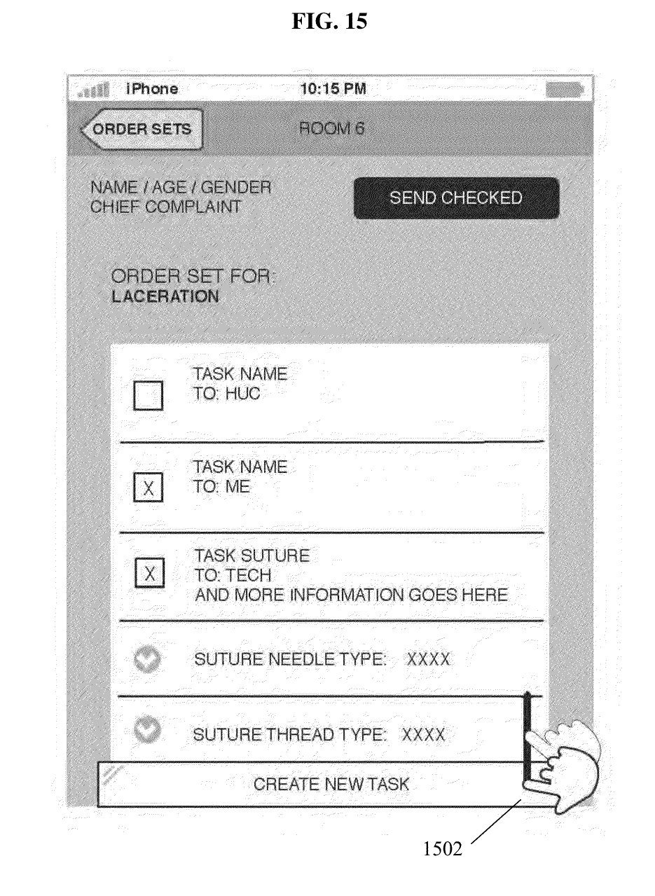

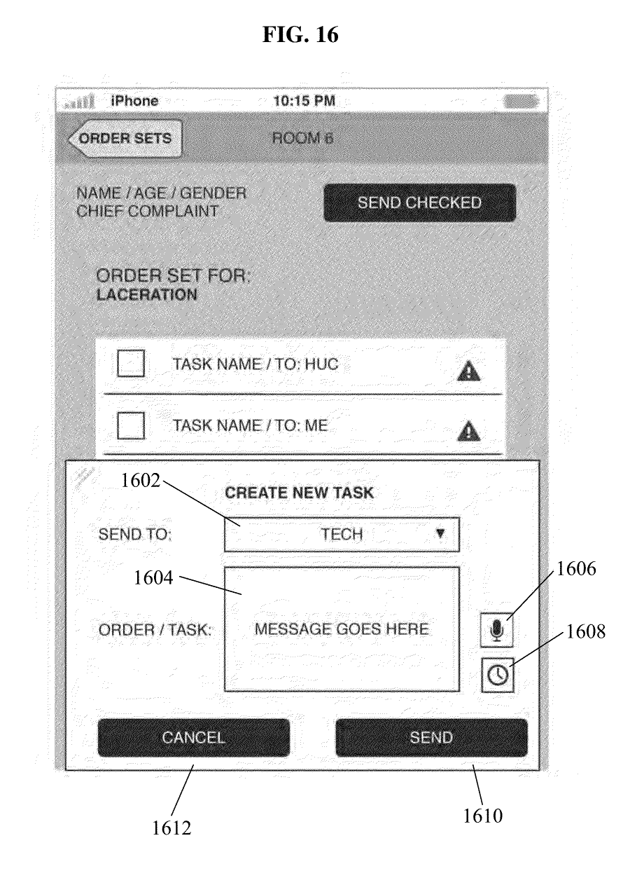

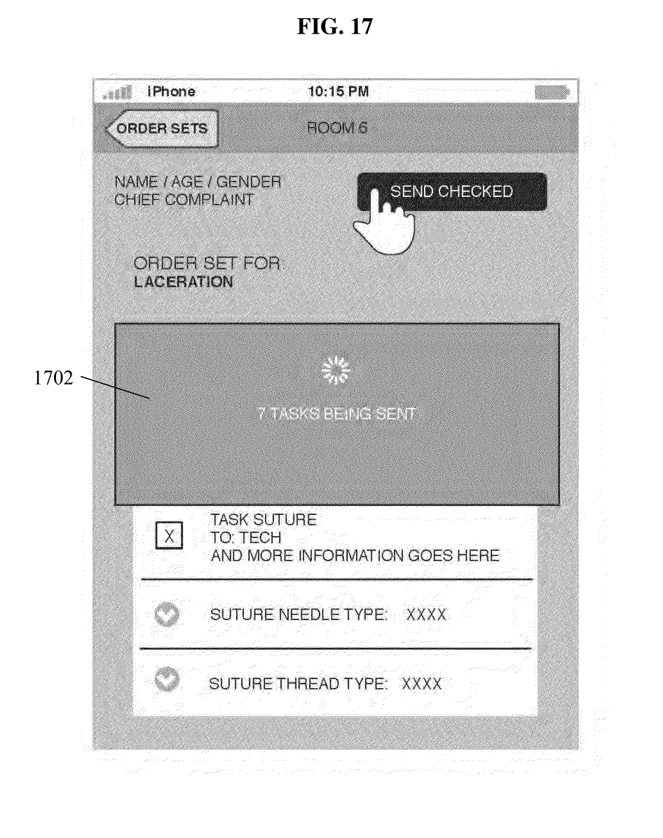

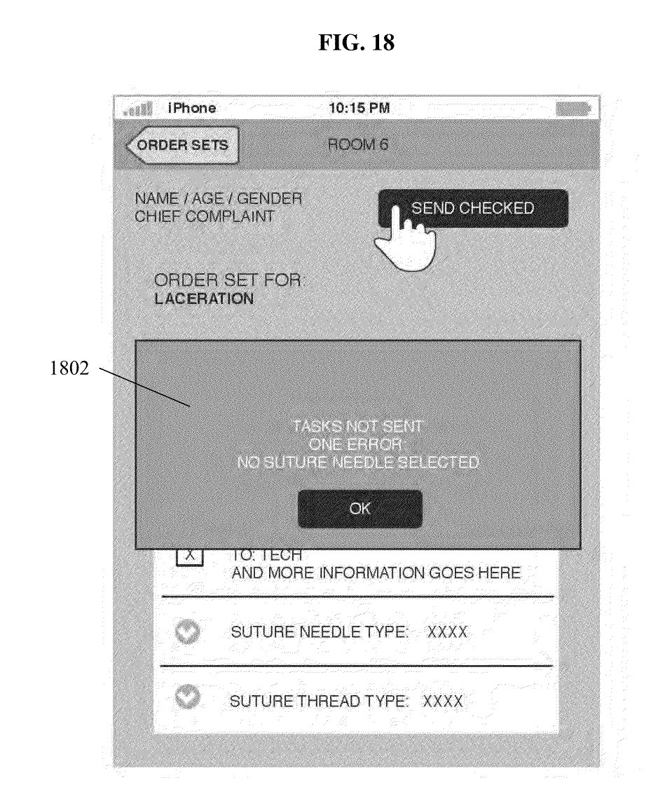

Referring to FIG. 14, the user has selected the order set for laceration. In addition to being able to create new tasks for an order set, the order set may already be populated with predetermined or default tasks 1402. The user can use this list to send tasks to him/herself or to another user. The user may deselect a checkbox 1404 to prevent the task from being sent. Tasks may also be editable by the user. As illustrated in FIG. 15, the user may flick from the bottom of the screen to create a new task 1502 from this interface. This process, illustrated in FIG. 16, is similar to that described in reference to FIG. 13. In the example of FIG. 16, the user can select a system user from a pre-populated drop down field 1602 containing a list of all members of the user's medical facility. The order or task can then be entered into a free text entry field 1604. The new task creation interface may include options for voice recognition 1606 or to set a timer for the task 1608. Once the task is entered, the user can select to send the task 1610 or delete or cancel the task 1612 if it is no longer needed. As illustrated in FIG. 17, this may trigger a popup confirmation message 1702 in some embodiments of the invention. As illustrated in FIG. 18, any errors detected by the system may trigger an error popup message 1802 in some embodiments.

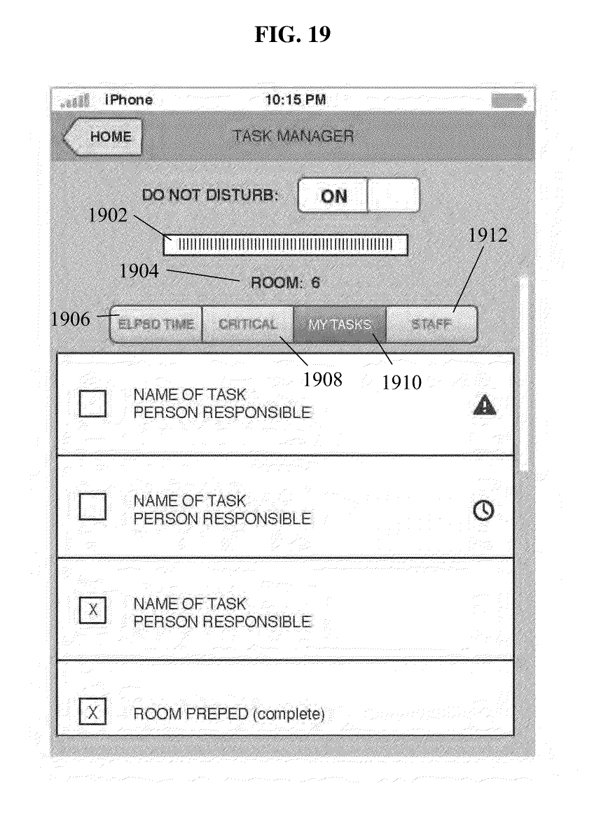

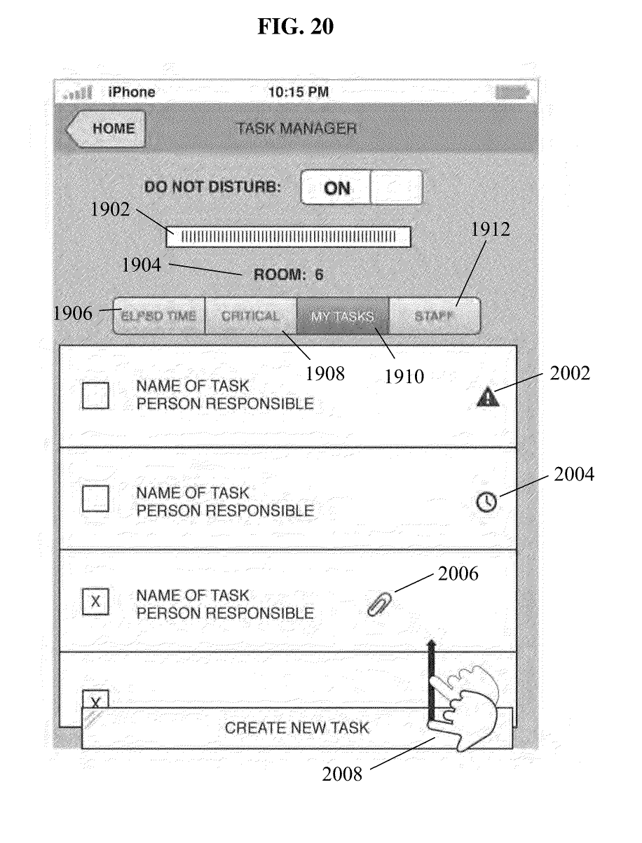

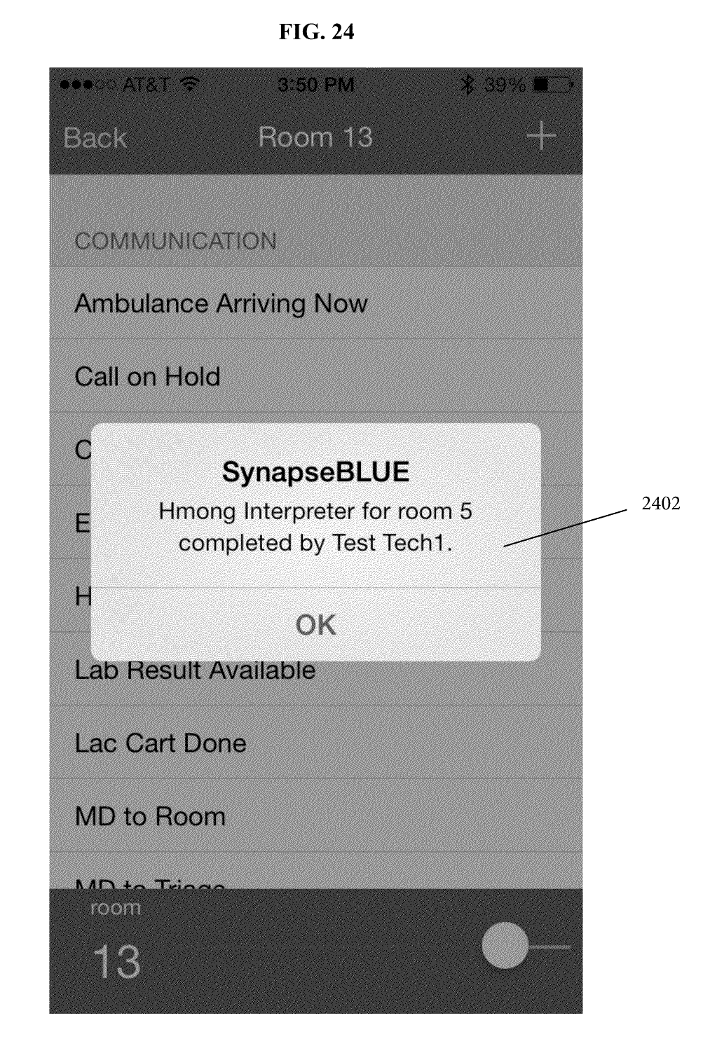

FIGS. 19 through 22 illustrate an example task manager interface according to one embodiment of the invention. In some embodiments, the system may include a wheel room select feature 1902 that can be used to rotate or scroll through all current rooms. This feature can be used to quickly switch from room to room. The selected room is shown 1904. A user has options to sort the tasks for the selected room, for example, by elapsed time 1906, by critical task 1908, by tasks assigned to the user 1910, or by staff 1912. The user can scroll through the task list according to the selected sorting option. In the example shown in FIG. 19, uncompleted tasks appear at the top of the list regardless of which sorting option is selected. Referring to FIG. 20, the task list shown in the task manager interface may include icons next to certain tasks, for example, critical task icon 2002, timed task icon 2004, or attachment icon 2006 next to tasks containing image(s), among others. The user may flick from the bottom of the screen to create a new task 2008 from this interface. As illustrated in FIG. 24, a notification 2402 can pop up on the screen telling a user that a requested task has been completed. The notification can also tell a user who completed the requested task.

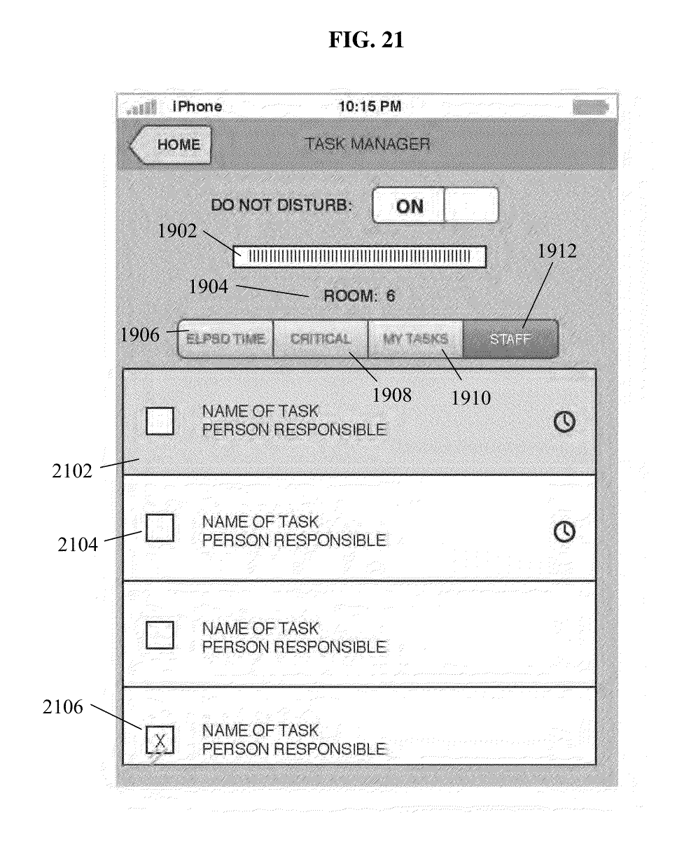

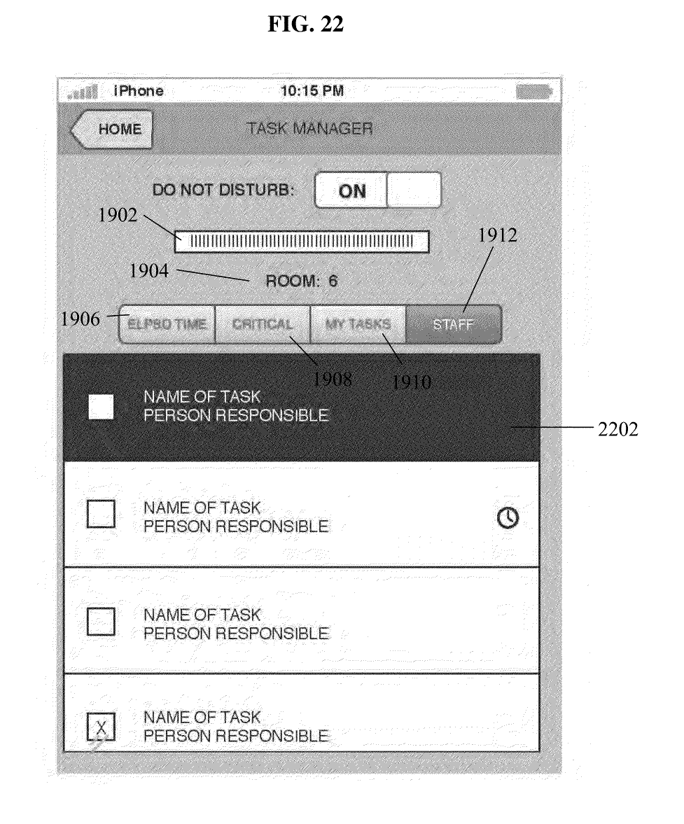

As an example, FIG. 21 illustrates the task manager when sorted by staff tasks 1912. In this example, tasks that have not been read by the recipient or staff member to whom the task is assigned may appear darker or shaded 2102. Also shown in this example, tasks that have been read but not completed may be indicated by a lighter appearance along with an unchecked completion box 2104. A task that has been read and completed 2106 is indicated in this example as having a lighter appearance and a checked or otherwise marked completion box. In this example, uncompleted tasks appear at the top of the list and completed tasks appear at the bottom. As illustrated in FIG. 22, if delivery of a task fails, this might be indicated as, for example, a dark or black item on the task list 2202. The system may function so that, in some embodiments, when certain tasks are complete, other tasks will be automatically issued to the user.

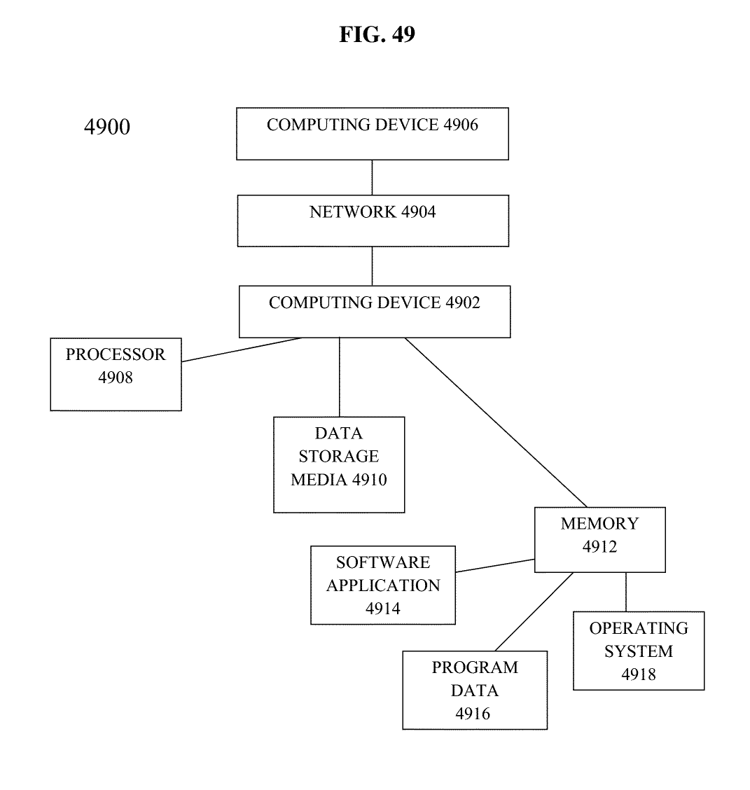

The disclosed invention involves technology that uses a computing system. FIG. 49 is a schematic block diagram of an example computing system 4900. The invention includes at least one computing device 4902. In some embodiments the computing system further includes a communication network 4904 and one or more additional computing devices 4906 (such as a server).

Computing device 4902 can be, for example, located in a place of business or can be a computing device located in a user's home. Computing device 4902 can be a stand-alone computing device or a networked computing device that communicates with one or more other computing devices 4906 across a network 4904. The additional computing device(s) 4906 can be, for example, located remotely from the first computing device 4902, but configured for data communication with the first computing device 4902 across a network 4904.

In some examples, the computing devices 4902 and 4906 include at least one processor or processing unit 4908 and system memory 4912. Depending on the exact configuration and type of computing device, the system memory 4912 may be volatile (such as RAM), non-volatile (such as ROM, flash memory, etc.) or some combination of the two. System memory 4912 typically includes an operating system 4918 suitable for controlling the operation of the computing device, such as the OS X operating system, or a server, such as a Mac Mini with OS X. The system memory 4912 may also include one or more software applications 4914 and may include program data 4916.

The computing device may have additional features or functionality. For example, the device may also include additional data storage devices 4910 (removable and/or non-removable) such as, for example, magnetic disks, optical disks, or tape. Computer storage media 4910 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 4902, 4906 can be located in a medical facility, such as a hospital, ED, or urgent care clinic. In other examples, the computing device can be a personal computing device that is networked to allow the user to access the present invention at a remote location, such as in a user's home or other location. In some embodiments, the computing device 4902 is a smart phone (such as an iPhone), tablet (such as an iPad) or other mobile computing device. In some embodiments the invention is stored as data instructions for a smart phone application. A network 4904 facilitates communication between the computing device 4902 and one or more servers, such as an additional computing device 4906, that host the system. The network 4904 may be a wide variety of different types of electronic communication networks. For example, the network may be a wide-area network, such as the Internet, a local-area network, a metropolitan-area network, or another type of electronic communication network. In one embodiment, this could include an Apple TV. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 4906 is a Web server. In this example, the first computing device 4902 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 4902 and 4906, the instructions cause the processor to perform one or more of the operations or methods disclosed herein. Examples of operations include communication between or among users; task list and order set management; dashboard functions; the storage of account information for multiple users; and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

1. A system for medical care task management comprising:
a computer network for management and transmission of indoor location and work status data of at least one care provider;
a data storage device for indoor location and work status data of the at least one care provider;
a server configured to receive indoor location and work status data of the at least one care provider;
at least one mobile computing device configured to transmit data including the at least one care provider's indoor location and work status data; and
a second computing device configured to manage work tasks and assign work tasks to the at least one care provider based on indoor location and work status of the at least one care provider.

2. The system of claim 1, wherein the mobile computing device is configured to transmit a care provider's indoor location by manual location reporting.

3. The system of claim 1, wherein the mobile computing device is configured to transmit a care provider's indoor location by automated detection of the location of the mobile computing device through at least one WiFi network router.

4. The system of claim 1, wherein the second computing device is configured to assign work tasks related to a patient to the care provider by reference to the proximity of the care provider to the patient.

5. The system of claim 1, wherein the second computing device is configured to assign work tasks related to a patient to the care provider by reference to the medical credentials of the care provider.

6. The system of claim 1, wherein the mobile computing device is configured to allow text communication with the second computing device.
